(19) United States
(12) Patent Application Publication
(10) Pub. No.: US 2011/0259443 A1
(43) Pub. Date: Oct. 27, 2011

(54) ANTIMICROBIAL FLUID HANDLING DEVICES AND METHODS OF MANUFACTURE

(76) Inventors: Stanley Preschutti, San Diego, CA (US); Arta Motadel, San Diego, CA (US)

(21) Appl. No.: 12/970,657

(22) Filed: Dec. 16, 2010

Related U.S. Application Data
(63) Continuation-in-part of application No. PCT/US2009/047541, filed on Jun. 16, 2009.
(60) Provisional application No. 61/073,342, filed on Jun. 17, 2008.
(60) Provisional application No. 61/144,029, filed on Jan. 12, 2009.

(51) Int. Cl. F16L 3/00

(52) U.S. Cl. 137/343

(57) ABSTRACT

Disclosed herein are antimicrobial fluid handling devices, such as pipette tips, pipette tip racks and pipette tip filters, for example.

### RELATED PATENT APPLICATION

This patent application is a continuation-in-part of International PCT Application PCT/US2009/047541, filed on Jun. 16, 2009, which claimed the benefit of U.S. Provisional Patent Application Nos. 61/073,342 and 61/144,029, filed on Jun. 17, 2008 and Jan. 12, 2009, respectively, each of which patent applications are entitled ANTIMICROBIAL FLUID HANDLING DEVICES AND METHODS OF MANUFACTURE, each naming Stanley Preschutti and Arta Motadel as inventors, and designated by attorney docket nos. PEL-1004-PC, PEL-1004-PV and PEL-1004-PV2, respectively. The entire content of the foregoing patent applications hereby is incorporated by reference, including all text, tables and drawings.

### FIELD OF THE INVENTION

The present invention relates to fluid handling devices. Such devices can be used in laboratories and in other settings, and can be utilized to process biological molecules.

### SUMMARY

A disadvantage of plastic articles used for handling biological samples and/or biological molecules is that the plastics used can be populated by microbes (i.e., germs) that can form a biofilm on a surface of the plastic body, such as on an outer and/or interior surface of the device, for example. This problem can occur even when such devices are provided in sterile form because microbes may come into contact with the device during use. Such disadvantages pertain to plastic devices for long-term and short-term use or storage.

Presented herein are solutions to this problem, that in particular: (i) decrease the amount of microbes present in or on a device, (ii) decrease the probability that microbes reside in or on a device, and/or (iii) decrease the probability that microbes form a biofilm in or on a device, for example. Devices presented herein decrease the likelihood of microbial contamination when they are used to process biological samples and/or molecules. Antimicrobial devices described herein find uses, for example, in laboratories, health care facilities and other settings in which biological samples and/or molecules are processed. Advantages of devices provided herein include, but are not limited to, (i) the devices are readily manufactured, (ii) the devices require fewer efforts, or no effort, by users to reduce the probability of significant microbial contamination and/or formation of microbial biofilm, and (iii) methods of using such devices provide for reasonably uncontaminated recovery of a biological material of interest. Devices described herein increase the probability that fluid handling devices provided without a microbial biofilm, without a significant microbe population, or no detectable biofilm or microbe population (e.g., sterile devices), maintain such properties.

Thus, the invention in part provides liquid handling and sample preparation antimicrobial devices. In some embodiments, the devices are useful for storing and/or processing biological samples, and in certain embodiments, the devices are useful for isolation, purification, concentration and/or fractionation of environmental samples and/or biological materials, such as nucleic acids and polypeptides, for example. Antimicrobial devices generally comprise one or more antimicrobial substances, such as one antimicrobial substance or combination of antimicrobial substances, in certain embodiments. An antimicrobial substance can be incorporated in the plastic material used to form a device (e.g., impregnated in the plastic device) in some embodiments, and in certain embodiments, an antimicrobial substance is coated on one or more surfaces of a device.

Antimicrobial devices can include one or more solid phase supports that interact with (e.g., bind to) biological materials by specific or non-specific interactions, in certain embodiments. The solid supports in some embodiments are particle or bead supports, sintered supports or fiber supports, and/or multicapillary supports, which may be coated or uncoated with an antimicrobial substance. A solid phase support may be incorporated into a device, such as a disposable pipette tip or pipette tip extension constructed from a thermoplastic or polymer, in certain embodiments. A solid phase support also may be incorporated into a pipette tip rack device in some embodiments. In certain embodiments, a solid a phase support is incorporated into such devices as laboratory liquid handling tubes, syringes and specimen containers, and in some embodiments, into a microfluidic device. In the foregoing embodiments, the device in contact with the solid phase support, the solid phase support or the solid phase support and the device comprise one or more antimicrobial substances.

Thus, featured in part herein is a polymer fluid handling device comprising an antimicrobial substance in an amount effective to confer microbial static properties and/or reduce the amount of microbe present on or in the device compared to a device not comprising the antimicrobial substance.

Also provided is a polymer fluid handling device comprising an antimicrobial substance in an amount effective to reduce the amount of microbe present on the device compared to a device not comprising the antimicrobial substance, wherein the device is selected from the group consisting of a pipettor, pipette tip, pipette tip rack, pipette tip filter, pipette tip extension, tube, centrifuge tube, syringe, microfluidic device, reagent reservoir, container and specimen container.

The invention in part also provides a polymer fluid handling device comprising an antimicrobial substance in an amount effective to reduce the amount of microbe present on or in the device, or to not allow for an increase in the amount of microbe present on or in the device (e.g., microbial static), compared to a device not comprising the antimicrobial substance. In some embodiments, wherein the antimicrobial substance is selected from the group consisting of silver, an alloy or compound containing silver, gold, an alloy or compound containing gold and an alloy or compound containing both silver and gold.

Provided also herein is a polymer fluid handling device comprising an antimicrobial substance in an amount effective to reduce or maintain the amount of microbe present on the device compared to a device not comprising the antimicrobial substance, wherein the amount of antimicrobial substance is in an amount between about 0.1% to about 10% based on the dry weight of the polymer.

In some embodiments a polymer fluid handling device is manufactured having an antimicrobial substance coating deposited on a surface of the device.

In certain embodiments a polymer fluid handling device comprises an antimicrobial substance in a coating, where the substance is in an amount between about 0.1% to about 5% based on the dry weight of the coating applied to the device. In some embodiments a polymer fluid handling device of any one of the preceding embodiments is manufactured wherein the amount of antimicrobial substance is in an amount between about 0.5% to about 5% based on the dry weight of the coating applied to the device.

In certain embodiments a polymer fluid handling device of any one of embodiments is manufactured wherein the antimicrobial substance is deposited as a layer having a thickness between about 2 Angstroms and about 10 microns. In some embodiments a polymer fluid handling device of any one of embodiments is manufactured wherein the antimicrobial substance is deposited by a physical vapor deposition technique selected from vacuum evaporation, sputtering, magnetron sputtering or ion plating, under conditions which limit diffusion during deposition and which limit annealing or recrystallization following deposition. In certain embodiments a polymer fluid handling device of any one of embodiments is manufactured wherein the antimicrobial substance is deposited such that the ratio of the temperature of the surface being coated to the melting point of the antimicrobial substance is maintained at less than about 0.5.

In some embodiments a polymer fluid handling device of any one of embodiments is manufactured which comprises an entity that interacts with a biological molecule. In certain embodiments a polymer fluid handling device of the above embodiment processes biological molecules that are selected from a nucleic acid, a peptide or a protein. In some embodiments a polymer fluid handling device of the above embodiment, contains an entity selected from the group consisting of silica, silica gel and controlled pore glass.

In certain embodiments a polymer fluid handling device of any one of embodiments is a pipette tip. A pipette tip device embodiment of the present invention may contain a volume of ranges from 0 to 10 microliters, 0 to 20 microliters, 1 to 100 microliters, 1 to 200 microliters or from 1 to 1000 microliters. A pipette tip device embodiment of the present invention may comprise a continuous and tapered polymer wall defining a first void and a second void located at opposite termini, wherein the cross section of the first void and the cross section of the second void are substantially circular and substantially parallel, and the diameter of the first void is less than the diameter of the second void, and an annular protrusion coextensive with the inner surface of the wall; the cross section of the annular protrusion is substantially parallel to the cross section of the first void and the second void; and the wall and the annular protrusion are constructed from the same polymer. A pipette tip device embodiment of the present invention may comprise a continuous and tapered first wall defining a first void and a second void located at opposite termini, wherein the cross section of the first void and the cross section of the second void are substantially circular and substantially parallel, and the diameter of the first void is greater than the diameter of the second void, and a continuous and tapered second wall defining the second void and a third void located at opposite termini; the cross section of the second void and the cross section of the third void are substantially circular and substantially parallel; the diameter of the second void is greater than the diameter of the third void; the second wall is coextensive with the first wall and the first wall and second wall are constructed from the same polymer; and the taper angle of the second wall is less than the taper angle of the first wall.

The invention also in part provides a method for manufacturing a polymer fluid handling device having an antimicrobial substance, which comprises: depositing an effective amount of an antimicrobial substance on a surface of the device; and depositing the antimicrobial substance such that the ratio of the temperature of the surface being coated to the melting point of the antimicrobial substance is maintained at less than about 0.5.

The invention also in part provides a method for manufacturing a polymer fluid handling device having an antimicrobial substance, which comprises: depositing an amount of an antimicrobial substance on a surface of the device; allowing the surface to dry; and applying an amount of an antimicrobial substance on another surface of the device.

The invention also in part provides a method for manufacturing a polymer fluid handling device having an antimicrobial substance, which comprises: mixing an antimicrobial substance with a polymer to form a polymer mixture; applying the polymer mixture to a mold; allowing the polymer mixture to form the polymer handling device in the mold; and releasing the polymer fluid handling device from the mold.

Aspects of antimicrobial devices and related methods are described in the Detailed Description, Claims and Drawings herein.

### BRIEF DESCRIPTION OF THE DRAWINGS

The drawings illustrate embodiments of the invention and are not limiting. It should be noted that for clarity and ease of illustration, these drawings are not made to scale and that in some instances various embodiments of the invention may be shown exaggerated or enlarged to facilitate an understanding of particular embodiments.

FIG. 1 shows an antimicrobial pipettor device.

FIG. 2 shows an antimicrobial filter device.

FIG. 3 shows an antimicrobial tip rack.

### DETAILED DESCRIPTION

Antimicrobial fluid handling devices incorporating, carrying or coated with an antimicrobial substance generally come into contact with an alcohol or water based electrolyte including a biological sample or biomolecule for any period of time such that microorganism deposition or growth on a device surface is possible but for the presence of the antimicrobial substance in the device.

### A. Antimicrobial Substances

A device may include one or more antimicrobial materials. An antimicrobial material may be coated on a surface (e.g., inner and/or outer surface) or impregnated in material that forms the body or component of a device, in some embodiments. One or more portions or sections, or all portions and sections, of a device may include one or more antimicrobial materials. Antimicrobial materials include, without limitation, metals, halogenated hydrocarbons, quaternary salts and sulfur compounds.

Antimicrobial metals include, without limitation, silver, gold, platinum, palladium, copper, iridum (e.g., noble metals), tin, antimony, bismuth, mercury, lead, cadmium, chromium, thallium and zinc (e.g., zinc pyrithione (also known as bis(2-pyridylthio)zinc 1,1′-dioxide; ZnP; pyrithione zinc; and zinc OMADINE)). A metal can be in any form such as salt, alloy, compound, solid or colloid, for example. A metal can be of a different form when placed in or on the device during manufacture than when active in the device ready for use. A metal or more than one metal may be applied or reapplied as a top or surface layer to the device prior to use. Factors such as costs, availability, and ease of use may aid in determining which anti-microbial metal or metals to select. Use of certain metals are preferred when handling biological materials such as animals cells, tissue, and DNA.

The afore-mentioned metal ions are believed to exert their effects by disrupting respiration and electron transport systems upon absorption into bacterial or fungal cells. Silver ion is one example of the relatively few antiseptic materials which are tolerated in biological samples at concentrations that are effective to kill microbes. Silver is useful because it is not substantially absorbed into a biological sample such as an animal cell. The metal can be silver or a silver compound in combination another metal or non-metal, in some embodiments. Water-soluble silver salts have been used as antiseptics, and are perhaps best known for disinfecting the eyes of newborn infants, thus preventing blindness. Among all heavy metal ions, silver ions have a very broad antimicrobial spectrum and high toxicity towards microorganisms in that they, e.g., bind to the cell wall via SH groups, block the respiratory chain, stop cell proliferation via DNA binding, but have low toxicity towards animal cells. A commercially accessible form of silver that can be utilized in devices described herein is SMARTSILVER NovaResin. SMARTSILVER NovaResin is a brand of antimicrobial masterbatch additives designed for use in a wide range of polymer application. Billions of silver nanoparticles can easily be impregnated into moldable substances (e.g., plastics, PET, PP, PE and nylon) using standard extrusion or injection molding equipment. SMARTSILVER NovaResin additives may be delivered as concentrated silver-containing masterbatch pellets to facilitate handling and processing. NovaResin is designed to provide optimum productivity in a wide range of processes, including fiber extrusion, injection molding, film extrusion and foaming.

Halogenated hydrocarbons, include, without limitation, halogenated derivatives of salicylanilides (e.g., 5-bromo-salicylanilide; 4′,5-dibromo-salicylanilide; 3,4′,5-tribromo-salicylanilide; 6-chloro-salicylanilide; 4′5-dichloro-salicylanilide; 3,4′5-trichloro-salicylanilide; 4′,5-diiodo-salicylanilide; 3,4′,5-triiodo-salicylanilide; 5-chloro-3′-trifluoromethyl-salicylanilide; 5-chloro-2′-trifluoromethyl-salicylanilide; 3,5-dibromo-3′-trifluoromethyl-salicylanilide; 3-chloro-4-bromo-4′-trifluoromethyl-salicylanilide; 2′,5-dichloro-3-phenyl-salicylanilide; 3′,5-dichloro-4′-methyl-3-phenyl-salicylanilide; 3′,5-dichloro-4′-phenyl-3-phenyl-salicylanilide; 3,3′,5-trichloro-6′-(p-chlorophenoxy)-salicylanilide; 3′,5-dichloro-5′-(p-bromophenoxy)-salicylanilide; 3,5-dichloro-6′-phenoxy-salicylanilide; 3,5-dichloro-6′-(o-chlorophenoxy)-salicylanilide; 5-chloro-6′-(o-chlorophenoxy)-salicylanilide; 5-chloro-6′-beta-naphthyloxy-salicylanilide; 5-chloro-6′-alpha-naphthyloxy-salicylanilide; 3,3′,4-trichloro-5,6′-beta-naphthyloxy-salicylalide and the like).

Halogenated hydrocarbons also can include, without limitation, carbanilides (e.g., 3,4,4′-trichloro-carbanilide (TRICLOCARBAN); 3,3′,4-trichloro derivatives; 3-trifluoromethyl-4,4′-dichlorocarbanilide and the like). Halogenated hydrocarbons include also, without limitation, bisphenols (e.g., 2,2′-methylenebis(4-chlorophenol); 2,2′-methylenebis(4,5-dichlorophenol); 2,2′-methylenebis(3,4,6-trichlorophenol); 2,2′-thiobis(4,6-dichlorophenol); 2,2′-diketobis(4-bromophenol); 2,2′-methylenebis(4-chloro-6-isopropylphenol); 2,2′-isopropylidenebis(6-sec-butyl-4-chlorophenol) and the like).

Also included within hydrogenated hydrocarbons are halogenated mono- and poly-alkyl and aralkyl phenols (e.g., methyl-p-chlorophenol; ethyl-p-chlorophenol; n-propyl-p-chlorophenol; n-butyl-p-chlorophenol; n-amyl-p-chlorophenol; sec-amyl-p-chlorophenol; n-hexyl-p-chlorophenol; cyclohexyl-p-chlorophenol; n-heptyl-p-chlorophenol; n-octyl-p-chlorophenol; o-chlorophenol; methyl-o-chlorophenol; ethyl-o-chlorophenol; n-propyl-o-chlorophenol; n-butyl-o-chlorophenol; n-amyl-o-chlorophenol; tert-amyl-o-chlorophenol; n-hexyl-o-chlorophenol; n-heptyl-o-chlorophenol; p-chlorophenol; o-benzyl-p-chlorophenol; o-benzyl-m-methyl-p-chlorophenol; o-benzyl-m, m-dimethyl-p-chlorophenol; o-phenylethyl-p-chlorophenol; o-phenylethyl-m-methyl-p-chlorophenol; 3-methyl-p-chlorophenol; 3,5-dimethyl-p-chlorophenol; 6-ethyl-3-methyl-p-chlorophenol; 6-n-propyl-3-methyl-p-chlorophenol; 6-iso-propyl-3-methyl-p-chlorophenol; 2-ethyl-3,5-dimethyl-p-chlorophenol; 6-sec butyl-3-methyl-p-chlorophenol; 6-diethylmethyl-3-methyl-p-chlorophenol; 6-iso-propyl-2-ethyl-3-methyl-p-chlorophenol; 2-sec amyl-3,5-dimethyl-p-chlorophenol; 2-diethylmethyl-3,5-dimethyl-p-chlorophenol; 6-sec octyl-3-methyl-p-chlorophenol; p-bromophenol; methyl-p-bromophenol; ethyl-p-bromophenol; n-propyl-p-bromophenol; n-butyl-p-bromophenol; n-amyl-p-bromophenol; sec-amyl-p-bromophenol; n-hexyl-p-bromophenol; cyclohexyl-p-bromophenol; o-bromophenol; tert-amyl-o-bromophenol; n-hexyl-o-bromophenol; n-propyl-m, m-dimethyl-o-bromophenol; 2-phenyl phenol; 4-chloro-2-methyl phenol; 4-chloro-3-methyl phenol; 4-chloro-3,5-dimethyl phenol; 2,4-dichloro-3,5-dimethylphenol; 3,4,5,6-terabromo-2-methylphenol; 5-methyl-2-pentylphenol; 4-isopropyl-3-methylphenol; 5-chloro-2-hydroxydiphenylemethane).

Halogenated hydrocarbons also include, without limitation, chlorinated phenols (e.g., parachlorometaxylenol, p-chloro-o-benzylphenol and dichlorophenol); cresols (e.g., p-chloro-m-cresol), pyrocatechol; p-chlorothymol; hexachlorophene; tetrachlorophene; dichlorophene; 2,3-dihydroxy-5,5′-dichlorophenyl sulfide; 2,2′-dihydroxy-3,3′,5,5′-tetrachlorodiphenyl sulfide; 2,2′-dihydroxy-3,3′,5,5′,6,6′-hexachlorodiphenyl sulfide and 3,3′-dibromo-5,5′-dichloro-2,2′-dihydroxydiphenylamine). Halogenated hydrocarbons also may include, without limitation, resorcinol derivatives (e.g., p-chlorobenzyl-resorcinol; 5-chloro-2,4-dihydroxy-di-phenyl methane; 4′-chloro-2,4-dihydroxydiphenyl methane; 5-bromo-2,4-dihydroxydiphenyl methane; 4′-bromo-2,4-dihydroxydiphenyl methane), diphenyl ethers, anilides of thiophene carboxylic acids, chlorhexidines, and the like.

Quaternary salts include, without limitation, ammonium compounds that include alkyl ammonium, pyridinum, and isoquinolinium salts (e.g., 2,2′-methylenebis(4-chlorophenol); 2,2′-methylenebis(4,5-dichlorophenol); 2,2′-methylenebis(3,4,6-trichlorophenol); 2,2′-thiobis(4,6-dichlorophenol); 2,2′-diketobis(4-bromophenol); 2,2′-methylenebis(4-chloro-6-isopropylphenol); 2,2′-isopropylidenebis(6-sec-butyl-4-chlorophenol); cetyl pyridinium chloride; diisobutylphenoxyethoxyethyldimethylbenzyl ammonium chloride; N-methyl-N-(2-hydroxyethyl)-N-(2-hydroxydodecyl)-N-benzyl ammonium chloride; cetyl trimethylammonium bromide; stearyl trimethylammonium bromide; oleyl dimethylethylammonium bromide; lauryidimethylchlorethoxyethylammonium chloride; lauryidimethylbenzyl-ammonium chloride; alkyl (Cg-Cig) dimethyl (3,4-dichlorobenzyl)-ammonium chloride; lauryl pyridinium bromide; lauryl iso-quinolinium bromide; N (lauroyloxyethylaminoformylmethyl) pyridinium chloride, and the like).

Sulfur active compounds include, without limitation, thiuram sulfides and dithiocarbamates, for example (e.g., disodium ethylene bis-dithiocarbamate (Nabam); diammonium ethylene bis-dithiocarbamate (amabam); Zn ethylene bis-dithiocarbamate (ziram); Fe ethylene bis-dithiocarbamate (ferbam); Mn ethylene bis-dithiocarbamate (manzate); tetramethyl thiuram disulfide; tetrabenzyl thiuram disulfide; tetraethyl thiuram disulfide; tetramethyl thiuram sulfide, and the like).

In certain embodiments, an antimicrobial material comprises one or more of 4′,5-dibromosalicylanilide; 3,4′,5-tribromosalicylanilide; 3,4′,5-trichlorosalicylanilide; 3,4,4′-trichlorocarbanilide; 3-trifluoromethyl-4,4′-dichlorocarbanilide; 2,2′-methylenebis(3,4,6-trichlorophenol); 2,4,4′-trichloro-2′-hydroxydiphenyl ether; Tyrothricin; N-methyl-N-(2-hydroxyethyl-N-(2-hydroxydodecyl)-N-benzylammonium chloride; cetyl pyridinium chloride; 2,3′,5-tribromosalicylanilide; chlorohexidine digluconate; chlorohexidine diaceate; 4′,5-dibromosalicylanilide; 3,4,4′-trichlorocarbanilide; 2,4,4′-trichloro-2-hydroxydiphenyl ether (TRICLOSAN; 5-chloro-2-(2,4-dichlorophenoxy)phenol); 2,2′-dihydroxy-5,5′-dibromo-diphenyl ether) and the like.

1. Amount of Antimicrobial Substance(s)

A device of the invention can include one or more antimicrobial substances. In general, devices of the present invention may contain any antimicrobial substance in any form that (i) does not allow a measurable, statistically significant or effective increase in microbes, or (ii) reduces the amount of microbes, present in or on the device compared to a device that does not have the antimicrobial substance(s). Any amount of antimicrobial substance effective to reduce or maintain the amount of microbe present on the device compared to a device that does not have the antimicrobial substance can be used. Factors such as duration of effectiveness, effectiveness activated by other elements or chemical properties, chemical form of the antimicrobial substance and the like can be taken into consideration. For example, surface-application chemistries vary on a device, but these applications are usually designed to deposit an antimicrobial substance (e.g., metallic silver or an ionic salt of silver) to the device surface.

Water content may affect activation of an antimicrobial substance. For example, forms of silver are activated when placed in the presence of moisture. A limitation of ionic salts alone is that they often are active only for a short period of time, sometimes only for a few days. By contrast, metallic silver nano-particles persist in delivering antimicrobial silver for as long as 100 to 200 days.

The amount of antimicrobial material can depend in part on the polarity of the antimicrobial material as compared to the polarity of material(s) used to manufacture a pipette tip device in embodiments where the antimicrobial material is mixed with the material(s) used to manufacture the pipette components. For example, where the antimicrobial material is more polar than material(s) used to manufacture components of a pipette tip, the antimicrobial material often will be present at a higher concentration at the pipette tip component surface. In some embodiments, less antimicrobial agent can be utilized when the antimicrobial agent has a significantly higher dipole moment than material(s) used to manufacture a pipette tip component.

By way of example, only, nanosilver particles (as small as 1000th the diameter of a bacterium) may constitute a reservoir of antimicrobial effect. This reservoir effect results when metallic silver, which has no antimicrobial properties, undergoes oxidation, which results in the release of the ionic form. Oxidation occurs at the surface of the particle when it is exposed to moisture such as fluids. Silver metal oxidizes very slowly, however, so it persists on the device to extend its usefulness. Because silver doesn't readily oxidize, nanoparticles are critical to achieving a reservoir effect. However, the smaller the particle size, the greater the ratio of surface area to volume, and the greater the area available for oxidation. For example, a gram of pure, solid silver in the form of a sphere has a surface area of 10.6 cm², whereas a gram of silver nanoparticles averaging 10 nm in diameter has a surface area of 0.6 million cm². This huge increase provides the surface area necessary to allow a continuous release of silver ions.

The form of an antimicrobial substance may be a factor for the amount of antimicrobial substance utilized. Certain mixtures are formed by mixing a polymer with a resin comprising an antimicrobial substance (e.g., a resin comprising TRICLOSAN or chemical variant thereof mixed with polypropylene, polyethylene or polyethylene teraphthalate). Admixing a polymer with a metal powder such as silver powder sometimes is not successful since, due to the small surface area, relatively high concentrations of metal powder will be necessary, which causes mechanical problems in the plastic material. The critical surface area required for antimicrobial activity, thus, often is not obtained by admixing metal powder. Anti-microbial powders (e.g., including nanocrystalline powders and powders made from rapidly solidified flakes or foils), however, can be formed with atomic disorder so as to enhance solubility. The powders, sometimes as pure metals, metal alloys or compounds such as metal oxides or metal salts, can be mechanically worked or compressed to impart atomic disorder. This mechanically imparted disorder is conducted under conditions of low temperature (i.e. temperatures less than the temperature of recrystallization of the material) to ensure that annealing or recrystallization does not take place, in some embodiments. The temperature varies between metals and increases with alloy or impurity content. Anti-microbial powders produced by this application may be used in a variety of forms or incorporated into a polymeric, ceramic or metallic matrix to be used as a material for devices or coatings thereof.

In certain embodiments, the antimicrobial substance (e.g., a resin comprising TRICLOSAN or chemical variant thereof) can be in any suitable form, such as pellets, for example. The antimicrobial pellets can then be blended or mixed in with the polymer material (e.g., mixed with polypropylene, polyethylene or polyethylene teraphthalate) used to form the fluid handling device. The polymer material can be of any suitable form, such as dry powder, for example. The antimicrobial pellets and polymeric powder can be blended and/or liquefied in any manner to be combined and then molded into either parts of and/or the entire body of the fluid handling device.

In certain embodiments, the amount of antimicrobial substance is in an amount between about 0.001% to about 0.005%, between about 0.005% to about 0.010%, between about 0.010% to about 0.015%, between about 0.015% to about 0.020%, between about 0.020% to about 0.025%, between about 0.025% to about 0.030%, between about 0.030% to about 0.035%, between about 0.035% to about 0.040%, between about 0.040% to about 0.045%, between about 0.045% to about 0.050%, between about 0.050% to about 0.055%, between about 0.055% to about 0.060%, between about 0.060% to about 0.065%, between about 0.065% to about 0.070%, between about 0.070% to about 0.075%, between about 0.075% to about 0.080%, between about 0.080% to about 0.085%, between about 0.085% to about 0.090%, between about 0.090% to about 0.095%, between about 0.095% to about 0.10%, between about 0.10% to about 0.15%, between about 0.15% to about 0.20%, between about 0.20% to about 0.25%, between about 0.25% to about 0.30%, between about 0.30% to about 0.35%, between about 0.35% to about 0.40%, between about 0.40% to about 0.45%, between about 0.45% to about 0.50%, between about 0.50% to about 0.55%, between about 0.55% to about 0.60%, between about 0.60% to about 0.65%, between about 0.65% to about 0.70%, between about 0.70% to about 0.75%, between about 0.75% to about 0.80%, between about 0.80% to about 0.85%, between about 0.85% to about 0.90%, between about 0.90% to about 0.95%, or between about 0.95% to about 1.0% based on the dry weight of (i) the polymer, or polymer mixture, used to manufacture a device or a device component, or (ii) components of a coating other than the antimicrobial substance. In some embodiments, the antimicrobial device has sufficient concentration of antimicrobial substance at the surface of the device to effectively reduce or maintain the amount of microbes present on the device, as compared to a device that does not have the antimicrobial substance.

In some embodiments, the antimicrobial substance can be TRICLOSAN, for example. The amount of TRICLOSAN is in an amount between about 2.00% to about 6.00% (e.g. 2.25%, 2.50%, 2.75%, 3.00%, 3.25%, 3.50%, 3.75%, 4.00%, 4.25%, 4.50%, 4.75%, 5.00%, 5.25%, 5.50%, and 5.75%) based on the dry weight of (i) the polymer, or polymer mixture, used to manufacture a device or a device component, or (ii) components of a coating other than the antimicrobial substance.

In certain embodiments, a device can include the antimicrobial substance zinc pyrithione, for example. Zinc pyrithione has the following structure:

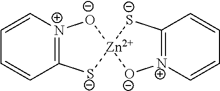

In a device or component thereof, zinc pyrithione is in an amount between about 0.05% to about 6.00% (e.g., about 0.06%, 0.07%, 0.08%, 0.09%, 0.10%, 0.15%, 0.20%, 0.25%, 0.30%, 0.40%, 0.50%, 0.60%, 0.70%, 0.80%, 0.90%, 1.00%, 1.25%, 1.50%, 1.75%, 2.00%, 2.25%, 2.50%, 2.75%, 3.00%, 3.25%, 3.50%, 3.75%, 4.00%, 4.25%, 4.50%, 4.75%, 5.00%, 5.25%, 5.50%, and 5.75%) in some embodiments, and sometimes the amount of zinc pyrithione is about 0.25% to about 2.00%, about 0.25% to about 1.00%, about 0.40% to about 0.70% or about 0.525% (e.g., about 0.425%, 0.450%, 0.475%, 0.500%, 0.525%, 0.550%, 0.575%, 0.600%, 0.625%, 0.650%, 0.675%), by weight. The term “by weight” is the ratio of the weight of the antimicrobial substance to the weight of (i) the polymer, or polymer mixture, used to manufacture a device or a device component, or (ii) components of a coating other than the antimicrobial substance. The weight often is determined when the antimicrobial substance and polymer are in dry or substantially dry form.

An effective amount of antimicrobial substance in or on a device, compared to a device that does not have the antimicrobial substance, may be determined by any method that detects one or more types of microbes. Such determinations can involve microbial detection methods including, but not limited to, microbial stain techniques, antibody detection techniques and microbial nucleic acid sequence detection techniques. An amount of a microbe detected on a device may be expressed in terms of number of microbes per unit area of the device, or over the entire device, or other expression selected by the person of ordinary skill in the art. An amount of microbial reduction on a device containing an antimicrobial substance, compared to a device that does not have the antimicrobial substance, can be expressed as a percentage of reduction. In certain embodiments, the amount of reduction of microbe present on a device comprising an antimicrobial substance, compared to a device that does not have the antimicrobial substance, is an amount between about 1% to about 5%, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80%, about 80% to about 85%, about 85% to about 90%, about 90% to about 95%, or about 95% to about 100%, based on surface area of the device (e.g., total surface area).

2. Incorporation or Deposition of Antimicrobial Substance

An antimicrobial device may be manufactured by any process or method known that allows incorporation of an antimicrobial substance into or onto the device. In certain embodiments, the antimicrobial substance is incorporated into the polymeric body of the device, and in certain embodiments, one or more surfaces of a device may be treated with an antimicrobial substance. In certain embodiments, incorporation of an antimicrobial substance into the molded body of the device may be a one- or two-step process in which different parts are molded separately and contain the same or different antimicrobial substance or mixture thereof.

In some embodiments, the device may include one or more applications of surface coatings of an antimicrobial substance or mixture thereof. In certain embodiments, incorporation of an antimicrobial substance onto the molded body of the device may be followed by a surface application of the same or different antimicrobial substance or mixture thereof. In some embodiments, a method of manufacturing an antimicrobial device can include adding specific additives to the polymer or antimicrobial substance or mixture, or excluding specific components from the mixture. In certain embodiments, a method of manufacturing the device can involve a pretreatment of the polymer or antimicrobial substance or mixture separately before forming the device, or conversely a post-treatment after assembly.

Methods for manufacturing devices and incorporating in, or depositing on, the device an antimicrobial substance are described in the section hereafter entitled “Methods of manufacturing devices.” Many polymeric compounds commonly used in fluid handling devices can be used as the starting material for the plastic body. Among these are, for example, polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers, crosslinked polysiloxanes, polyurethanes, (meth)acrylate-based polymers, cellulose and cellulose derivatives, polycarbonates, ABS, tetrafluoroethylene polymers, corresponding copolymers and the like. Polyurethane, polyethylene and polypropylene as well as polyethylene-polypropylene copolymers may be preferred. One or several polymer materials may be used in the preparation of the plastic bodies according to the invention. Further additives can also be added to the mixture of plastic(s). Examples of antimicrobial substances that can be added to the mixture of plastic(s) include one or more of those described herein (e.g., TRICLOSAN; 5-chloro-2-(2,4-dichlorophenoxy)phenol); 2,2′-dihydroxy-5,5′-dibromo-diphenyl ether). Examples of antimicrobial metals that can be added include, without limitation, silver, copper, gold, zinc or cerium, or combinations thereof. Further examples include, without limitation, inorganic particles such as barium sulfate, calcium sulfate, strontium sulfate, titanium oxide, aluminium oxide, silicon oxide, zeolites, mica, talcum, kaolin and the like. Prior to molding, one or several polymer components and/or one or several of the inorganic additives may be treated with an antimicrobial substance resin or solution (e.g., colloidal metal solution) in some embodiments.

After mixing the starting materials which have in part been treated with an antimicrobial substance, the resulting mixture may be further processed in order to obtain a molded plastic article. Such further processes can be performed with equipment that includes, without limitation, mixers, kneaders, extruders, thermoforming apparatus, injection molding apparatus, (hot) presses and the like, and as described further hereafter (“Methods of manufacturing devices” section). In some embodiments, pellets containing an antimicrobial substance such as TRICLOSAN, can be mixed with a powder form of polymer, then the mixture is liquefied and blended together to form part of or the entire body of the fluid handling device.

In certain embodiments, metal colloids are utilized, are suitably prepared by reducing metal salt solutions, and/or are with contacted with plastic materials or inorganic particles. Protective agents such as gelatin, silica or starch may be used to stabilize the resulting colloid in certain embodiments. In some embodiments, a metal colloid is prepared by slowly blending a metallic nitrate solution in gelatin with a suitable reducing agent. The reducing agent can be selected from aldehydes (e.g. acetaldehyde), aldoses (e.g. glucose), quinones (e.g. hydroquinone), inorganic complex hydrides (sodium or potassium boranate), reducing nitrogen compounds (hydrazine, polyethylene imine) and ascorbic acid. Plastic precursors such as pellets and/or said inorganic particles such as barium sulfate may be treated with colloidal metallic solution, dried and molded into the respective shape. Applying the metallic colloid onto the starting materials and subsequent drying can be repeated several times so that in this way very high metallic concentrations can be introduced into the plastic material. This suspension may by filtered, washed dried and processes may be repeated several times. The use of e.g. gelatin, (fumed) silica or starch as a colloidal stabilizer can be omitted if the metal is adsorbed by the inorganic particles, since the microcrystalline metal particles produced during reduction bind to the surface of said inorganic particles via adsorption and, thus, the formation of a continuous metal coating on the solid is avoided. Water soluble adjuvant chemicals used can be removed with water. By varying or omitting the colloidal stabilizers as well as the reducing agents, the particle size of the metal and, thus, the mobility of the resulting metallic ions can be controlled over a wide range. Furthermore, to achieve strong adhesion to the polymer, low-molecular aldehydes may be used as the reducing agents which partially crosslinks the gelatin.

### B. Devices and Components Thereof

The invention in part pertains to a fluid handling device (e.g., one used to contact a biological sample or biological molecule) that comprises an antimicrobial substance. Polymer pipette tip devices and racks, pipette tip filters, laboratory fluid handling tubes, centrifuge tubes, syringes, specimen containers, and microfluidic devices that comprise an antimicrobial substance are non-limiting examples of antimicrobial fluid handling devices. Some devices are useful for the isolation, purification, concentration and/or fractionation of biological materials of interest from a variety of samples. Certain devices combine and provide the benefits of chromatography, isolation, purification, concentration and or fractionation without using centrifugation. Devices described herein can be utilized in manual or automated/robotic applications in volumes ranging from sub-microliter (e.g., nanoliter) to milliliter volumes. Certain devices have the additional benefit of being readily applicable to a variety of methodologies, including pipette tip-based isolation, purification and concentration and/or fractionation of biological materials for ease of use and reduced cost.

The antimicrobial substance can be located in a part or parts of the device or throughout the entire body of the main device or as a coating. For example, the antimicrobial substance may be coated on the inner lumen of a fluid handling device. In certain embodiments, the antimicrobial substance can be blended with a polymer and molded as a lid which tethers to a fluid handling device such as a tube (e.g., centrifuge tube), for example.

Certain sample preparation devices provided herein are cost-effective, adaptable to many protocols, are not reliant on conventional chromatographic matricies, and do not require the use of centrifugation or other specialized equipment that can affect the quality of the material recovered. Thus, sample preparation devices described herein are useful for fluid handling and are ideal for antimicrobial applications.

1. Pipettors and Pipette Tip Devices

Pipette tips typically are used to acquire, transport or dispense fluids in various laboratory settings. Pipette tips can be used in large quantities in both medical and research settings where handling of large numbers of biological samples is necessary. Pipette tips can be used manually, where an operator uses either a single channel pipette or a multichannel pipette (more than one dispensing outlet, typically available in 2, 4 or 8 channel configurations), and pipette tips can also be used in automated or robotic applications in some embodiments. In automated or robotic applications, the robotic devices can be configured to also use 1, 2, 4, 8, 16, 24, 32, 40, 48, 56, 64, 72, 80, 88, 96, 384 or 1536 channel pipettes. Pipettes with 96 or more channels generally are used in microtiter plate or array/chip applications where high throughput analysis of a large number of samples is required, for instance, in laboratories or medical clinics where PCR, DNA chip technology, protein chip technology (chip technology is also known as arrays), immunological assays (ELISA, RIA), or other large number of samples must be processed in a timely manner. One example of an automated or robotic device used for high throughput analysis is a device referred to as the Oasis LM (produced by Telechem International, Inc. Sunnyvale Calif. 94089). This computer-driven biological workstation can be configured with up to 4 separate pipette tip heads with the ability to pipette 1, 8, 96, 384 or 1536 samples. The range of volumes is dependent on the particular head and pipette tip combination, and the volume range for the workstation is from 200 nanoliters to 1 milliliter. The workstation can operate all four pipette heads simultaneously.

Pipette tips often are available in sizes that hold from 0 to 10 microliters, 0 to 20 microliters, 1 to 100 microliters, 1 to 200 microliters and from 1 to 1000 microliters While the external appearance of pipette tips may be different, pipette tips suitable for use with the embodiments presented herein often have a continuous tapered wall forming a central channel or tube that is roughly circular in horizontal cross section. However, any cross-sectional geometry can be used providing the resultant pipette tip device provides suitable flow characteristics, and can be fitted to a pipette. Pipette tips useable with the embodiments described herein often taper from the widest point at the top-most portion of the pipette tip (pipette proximal end or end that fits onto pipette), to a narrow opening at the bottom most portion of the pipette tip (pipette distal or end used to acquire or dispel samples). In certain embodiments, a pipette tip wall can have two or more taper angles. While the inner surface of the pipette tip often forms a tapered continuous wall, the external wall may assume any appearance ranging from an identical continuous taper to a stepped taper or a combination of smooth taper with external protrusions. The upper-most outer surface of commonly available pipette tips often are designed to aid in pipette tip release by the presence of thicker walls or protrusions that interact with a pipette tip release mechanism found in many commercially available pipette devices. Additional advantages of the externally stepped taper are compatibility with pipette tip racks from any manufacturer. The thicker top-most portion of certain pipette tips also allows for additional rigidity and support such that additional pressure can be applied when pressing the pipette into the opening of the pipette tip to secure the pipette tip on the pipette, thus ensuring a suitable seal. The bore of the top-most portion of the central channel or tube generally is large enough to accept the barrel of a pipette apparatus of appropriate size. As most pipette apparatus are capable of being used with universal pipette tips made by third party manufacturers, different pipette tip sizes may be used with pipettes of different volumetric ranges. Therefore a pipette tip designed for use with a pipette used for handling samples of 1 to 10 microliters generally would not fit on a pipette designed for handling samples of up to 1000 microliters. The design and manufacture of standard pipettes and pipette tips is known, and injection molding techniques often are utilized.

The term “pipette tip device” as used herein refers to a pipette tip suitable for isolation, purification, concentration and/or fractionation of biological samples, where the device often is constructed of standard, commercially available pipette tips of any size or shape. The pipette tip housing often is manufactured from a polymer, which can be of any convenient polymer type or mixture for fluid handling (e.g., polypropylene, polystyrene, polyethylene, polycarbonate). A pipette tip device can be provided as a RNase, DNase, and/or protease free product, and can be provided with one or more filter barriers. Filter barriers are useful for preventing or reducing the likelihood of contamination arising from liquid handling, and sometimes are located near the pipette tip terminus that engages a manual or robotic pipettor in certain embodiments.

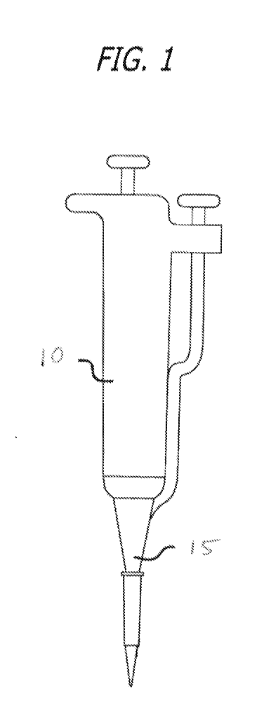

Pipettors may be exposed to microbes in a variety of ways as well as on different parts of the device itself. The handle portion of the pipettor, is an example of where microbes may contaminate the device as shown as item 10 in FIG. 1. The interior as well as the exterior portions of the barrel shaft also may be exposed to microbes, for example, by the sample being pipetted and/or by being manually handled as shown as item 15 in FIG. 1. Therefore any portion of a pipettor may be an environment microbes could contaminate. Thus, provided herein are dispenser devices having one or more components and/or surfaces that contain, and/or are coated with, an antimicrobial substance.

In certain embodiments of a pipettor device as provided herein, an antimicrobial material may coat the external and/or internal portions of the device or portions thereof as shown in FIG. 1. In some embodiments of a pipette tip device as provided herein, an antimicrobial material may coat the inner and/or outer surface of the device or portions thereof.

2. Polymer Pipette Tip Extension Device

As used herein “pipette tip extension device” refers to a particular embodiment which does not involve placing an insert into a pipette tip, but rather is a prefabricated polymer housing that contains an insert and a pipette tip adaptor at the topmost portion of the device, into which a pipette tip of the appropriate size is placed and secured in place by applying downward pressure to the pipette tip. “Polymer housing” refers to the plastic material used to contain the insert. The polymer housing can be of any convenient polymer or polymer mixture for fluid handling (e.g., polypropylene, polystyrene, polyethylene, polycarbonate). A pipette tip extension device can be provided as a RNase, DNase, and/or protease free product, and can be provided with one or more filter barriers. Filter barriers are useful for preventing or reducing the likelihood of contamination arising from liquid handling, and sometimes are located near the pipette tip adaptor component in certain embodiments.

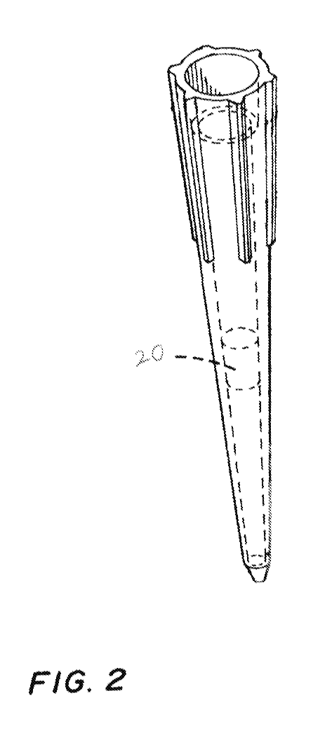

A pipette tip extension device includes a pipette tip adaptor component that can mate with a pipette tip fluid discharge end by a suitable connection, such as a friction, compression or lock fit, for example. The pipette tip adaptor component can include any suitable structure for mating the pipette tip, including without limitation, one or more barbs, protrusions (e.g., annular protrusions, described above), dimples (described above), o-rings, and luer lock structures. The diameter of the first void and a portion of the housing contiguous with the first void often are adapted to fit over the fluid delivery terminus of a pipette tip, the latter of which describes the portions of and the manner in which the pipette tip and the pipette tip extension device often are mated (e.g., illustrated in FIGS. 2A and 2B). The diameter of the portion of the polymer housing contiguous with the first void sometimes is marginally larger than, sometimes is the same as, and sometimes is marginally smaller than the diameter of the pipette tip fluid emission end, and is configured such that once mated, the pipette tip and pipette tip extension device are not dislodged during pipetting of fluids. A user may dispose of a pipette tip and extender combination after use, or may remove the extender from the pipette tip after use, in certain embodiments.

An insert can be retained in a pipette tip extension device by any suitable retaining structure or method. Non-limiting examples of structures that retain an insert include, without limitation, one or more protrusions in contact with the inner surface of the pipette tip extension device wall (e.g., annular protrusions and dimples described above) one or more contiguous walls having different wall angles from vertical (e.g., described above). An insert also can be retained in an extension device by deforming a portion of a wall of the device in contact with the insert, including without limitation, heat (e.g., partially melting the wall) and mechanical crimping. A pipette tip extension device also may be configured without an insert, and include a combination of plugs and beads, or a combination of slots, plugs and beads, as described herein. In some embodiments, an antimicrobial material may coat one or more of the inner surface, outer surface, protruding surfaces and/or inserts of the device, or portions thereof, or may be impregnated into polymer that forms the device.

3. Pipette Tip Filter

Pipette tips are cone-shaped hollow vessels open at their upper and lower ends which are commonly used to acquire, transport, and dispense fluid samples. In use, a pipettor, which comprises a suction means, generally is secured to the upper end of the pipette tip to form a seal with the pipette tip. The lower end of the pipette tip is then placed in contact with the liquid to be sampled. The pipettor is then operated to draw air from inside the pipette tip at the upper end, and the resultant suction draws the sampled liquid into the pipette tip. Air pressure maintains the liquid inside the pipette tip until the pipettor is operated to release the liquid, generally by expelling the drawn air.

A common concern in the use of pipette tips is that the pipettor may become contaminated by the sampled fluid. This contamination may pose health risks to the operators of the pipettor, who may become exposed to dangerous substances contained in samples, in certain circumstances. Contamination can also damage the pipettor, and can obscure results of future sample testing if pipette tips subsequently used with the pipettor become contaminated. In applications such as DNA testing, where minute amounts of sample may replicate, such sample distortion is of great concern, for example.

Pipettor contamination often results from contact between the pipettor and aerosol droplets of the fluid aspirated during acquisition, transfer and expulsion of a fluid sample. Contamination may also result from overpipetting, in which too much suction is applied to the upper end of the pipette tip, drawing enough fluid into the pipette tip to contact the pipettor.

To combat problems associated with contamination, pipette tip devices include a filter plug between the upper and lower end of the pipette tip in certain embodiments (e.g., item 20 in FIG. 2). Pipette tips also may be provided with an antimicrobial filter in certain embodiments. In some embodiments an antimicrobial filter may comprise beads, fibers, a matrix or an array of material, a solid or semi-solid plug, or a combination thereof. In certain embodiments, an antimicrobial filter can comprise polyester, cork, plastic, silica, gels, or a combination thereof. In some embodiments an antimicrobial filter may be porous, non-porous, hydrophobic, hydrophilic or a combination thereof.

In some embodiments, when a pipette tip with a filter is placed upon a pipettor, the filter and inner surface of the pipette tip may interstitially define a number of vertically-oriented pores such that the filter may seal against the inner surface of the tube. The pores may be distributed according to a pore distribution that defines varying pore sizes within the filter, which are dependent upon the volume defined by the inner surface of the pipette tip and the cross-sectional horizontal density of the filter material. The pore size of a filter may be of any size that aids in the function of the filter. In some embodiments, an antimicrobial filter may have a maximum pore size be ten micrometers or less or three micrometers or less. In certain embodiments, an antimicrobial filter may have a mean, average or nominal pore size of 10, 9, 8, 7, 6, 5, 4, 3, 2, 1, 0.5, or 0.05 micrometers. In some embodiments, an antimicrobial material may coat the top and/or bottom surface of the filter device or portions thereof as shown in FIG. 2.

4. Pipette Tip Rack

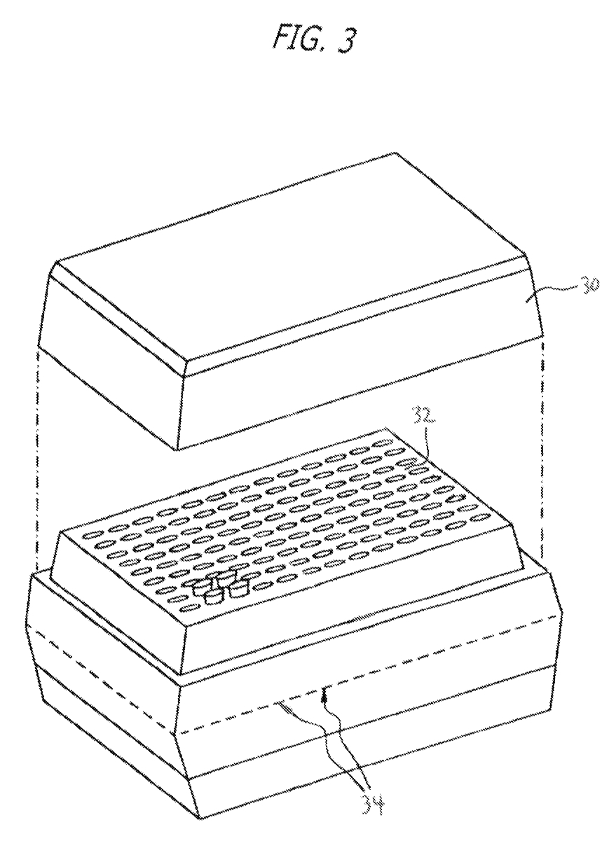

Tips for use with syringes and pipetting devices (e.g., pipette tips) typically are supplied in trays or holders, each tray sometimes having openings for receiving 96, 192, 288, 384, 480, 576, 672, 768, 864, 960, 1056 or 1152 pipette tips, for example. Typically, trays are packaged in an outer box which may have a bottom portion, item 34 in FIG. 3, and a top/lid portion, item 30 in FIG. 3, and both the box and the trays are discarded when the tips have been used. The tip holders or trays, as shown as item 32 in FIG. 3, often come prepackaged with the tips already inserted, but there are also commercially available means of loading loose tips into tip holders. Alternatively, the tips can be manually placed into the holes of a tip holder. Once the tips are loaded into a tip holder, the tip holder is placed or snapped or secured into a support structure such as an outer box and the tips, variably with or without the tip holder, are released from the tip holder and box upon use. In certain embodiments, the tip holder and outer box is one unit or the tip holder and the bottom portion of the outer box are one portion. Thus there are many opportunities for microbial contamination of the pipette tips from manually handing the tips before use.

A function of the outer box is to provide support during the tip removal process. Typically, the tips are removed when an instrument, which often is manually or machine operated, is inserted into the larger open top of the tip, and downward pressure is exerted, thus wedging the tip onto the instrument. The tip then is removed from the box, used and subsequently discarded. The top lid of the box may be made from a different material than the bottom of the box. In some embodiments, the lid and/or rack base independently are manufactured from polyethylene or another polymer described herein, or blend thereof. In certain embodiments, the lid (e.g., 30 in FIG. 3), the rack (e.g., snap plate 32 and base 34 in FIG. 3), or lid and rack, include an antimicrobial substance described herein (e.g., zinc pyrithione). In some embodiments, the top lid may be transparent or substantially transparent so that the user can easily identify the top of the box and store it vertically.

The box acts to provide physical underlying support for pipetting processes, such that when downward pressure is exerted, the tip does not move downward or become misaligned with the instrument. The tip holder remains at the top of the box and assists by keeping the tips aligned in their respective holes. The tip holder alone sometimes does not provide sufficient support, however, because the tip holder often is a fairly thin and flexible tray that is not a free standing independent support mechanism. An outer box for the tip holders therefore sometimes is provided.

In many settings in which pipette tips are used, it is desirable to minimize the user's handling of the tips and thus prevent or minimize microbial contamination that may be introduced into the sample being pipetted. However, some tips are susceptible to becoming displaced from the tip holder and to requiring manual repositioning in the tip holder or support structure. The tips may also become inadvertently displaced both when they are initially positioned in the support structure and when they are lifted out of the box and holder structure for use.

It has been observed that when a user is removing a tip from a tip holder, the tip holder may be inadvertently lifted relative to the support structure so that it requires repositioning before use is resumed. Such inadvertent lifting may occur, for example, when a tip or a row of tips is being removed at an angle other than perpendicular to the tip support. When the tip holder is so lifted, typically the user must handle the system to reposition the tip holder and any displaced tips. It is therefore desirable to provide a pipette tip holder and box support structure which are antimicrobial in nature and prevent microbial contamination of the pipette tips as the tips are removed. In some embodiments one or more surfaces of the following portions of a pipette tip rack device comprises (e.g., is impregnated with or is coated with) an antimicrobial material: exposed surfaces of the tip holder, exposed surfaces of the outer box, surfaces in contact with the pipette tips or any portions that may be manually handled (e.g., shown in FIG. 3).

5. Laboratory Liquid Handling Tubes, Syringes and Container Devices

Many laboratory or clinical procedures require collecting, manipulating, preparing, or fractionating samples in tubes, syringes, reagent reservoirs or containers of differing sizes. Microcentrifuge tubes (e.g., EPPENDORF tubes) often are utilized due to their availability in convenient sizes (250 microliter tubes, 500 microliter tubes, 1.5 milliliter tubes and 2 milliliter tubes), their sturdy design (capable of withstanding centrifugation, heating, cooling to temperatures below −70 degrees C., resistance to many solvents and chemicals) and availability as RNase and DNase free products with low liquid retention. These tubes also are available in configurations which have a locking lid affixed to the tube body by a hinge co-extensive from the tube body, or with a standard screw cap top. The tubes also are available in various colors and with specialized surfaces on the outside of the tube for labeling. While these tubes have gained acceptance and use as a preferred laboratory liquid handling tube, the usefulness of these tubes can be limited to volumes of 2 milliliters or less. Many laboratories and medical clinics also have a requirement for collecting, storing and/or processing samples greater than 2 milliliters in size or samples that may contain solids. In these instances specimen containers are used. Specimen containers are typically made from the same materials used for microcentrifuge tubes and so have many of the same advantageous properties. Typically these tubes have either a screw cap top, or a lid that that snaps securely in place to the body of the specimen container to provide a leak resistant or leak proof seal. The lids can be made of the same or a different material as the body. The specimen containers can have a tapered body or a non-tapered body. They have the additional added benefit of being able to handle liquid, solid or a combination of liquid and solid samples of larger sizes. Specimen containers (also sometimes referred to as specimen cups) are also available in a variety of sizes (about 15 milliliters, 20 milliliters, 4 ounces (about 125 milliliters), 4.5 ounces, 5 ounces, 7 ounces, 8 ounces (about 250 milliliters) and 9 ounces), allowing collection, storage, and/or processing of samples of over 300 milliliters. Another type of fluid handling device is a syringe or a dispensing device which is arranged to dispense an accurate and measured dose of a fluid. Syringes can not only be a container of fluids but it can also deliver fluids in a specific quantify. A syringe tubular body forms a fluid receiving chamber having a restricted opening at one end for receiving a hollow needle and a wider opening at the other end for receiving a tubular plunger. The plunger has resilient fingers at its distal end which is inserted into the body chamber and an annular groove in one embodiment adjacent the proximal end. The fingers have inwardly extending hook-like projections. A piston assembly includes a body with an annular groove which releasably receives the projections for securing the piston assembly to the plunger during injection, the piston assembly including an elastomeric disc piston sealingly engaged with the tubular body chamber sides. Other reagent reservoirs or any structure that can hold reagents such as microtiter plates, macrotiter plates and the like, or structures that may come into contact with the reagents in a reagent reservoir such as tops, lids, adhesive or non-adhesive covers also are included. One of skill in the art understands that new products which perform the equivalent function and products of differing sizes are developed continuously. Therefore one of skill in the art will understand that containers not listed herein, but equivalent in function and of possibly different sizes are envisioned as being equivalent and therefore usable in the embodiments described herein. Laboratory liquid handling tubes, syringes and specimen containers may be utilized to contain a biological sample (e.g., urine, semen, blood, plasma, sputum, feces, mucous, vaginal fluid, spinal fluid, brain fluid, tears cells and the like).

Laboratory liquid handling tubes, syringes and specimen containers are manufactured from a variety of materials. Common materials used for the manufacture of these types of tubes and containers are polypropylene, polyethylene, and polycarbonate. Other thermoplastics or polymers also may be used. Many of the commercially available tubes, syringes and containers come pre-sterilized or with guarantees of being RNase, DNase, and protease free. For the purpose of these embodiments, any material that has good chemical or solvent resistance, has low liquid retention (i.e., made of hydrophobic materials or coated to be hydrophobic), is safe for the handling of biological materials (RNase, DNase, and protease free), and that can withstand heating and extreme cooling is suitable for use.

A limitation of standard laboratory liquid handling tubes, syringes and specimen containers is that none of these types of container reduce the number of steps required to isolate, purify, concentrate and/or fractionate biological materials. One example would be preparation of protein or nucleic acid from a cell lysate. Regardless of the size of the sample, multiple tubes and processing steps are required to arrive at the final protein or nucleic acid material desired. This involves transferring the sample between different tubes or containers after each step or series of steps. Each transfer potentially loses sample or potentially introduces a contaminant that can alter recovery or destroy the samples completely. Thus, the present devices can reduce the number of steps and transfers required to arrive at a final biological material of interest, and thus save time, money and reduce sample loss.

In some embodiments, a tube device comprises an antimicrobial material, and the antimicrobial material may be impregnated in, or coat, the inner and/or outer surface of the tube device or portions thereof. In some embodiments of a syringe device as provided herein, an antimicrobial material may coat the inner and/or outer surface of the device, the fluid receiving chamber, the tip aperture or portions thereof. In some embodiments of a specimen containers device as provided herein, an antimicrobial material may coat the inner and/or outer surface of the container device or lids/covers/tops or portions thereof.

6. Microfluidic Devices

Microfluidic devices of increasing sophistication and ability have been developed and are commercially available. Advances in semiconductor manufacturing and nanotechnology have been translated to the fabrication of micromechanical structures such as micropumps, microvalves, and microelectrophoretic systems. U.S. Pat. No. 6,168,948 to Andersen et al. and U.S. Pat. No. 6,638,482 to Ackley et al. both incorporated herein in their entirety by reference and for all purposes, are examples of microfluidic devices that include miniature chambers and flow passages. Due to the increasing sophistication of these microfluid devices, it is now possible to take whole cells and process them for the purpose of isolating various biological molecules of interest completely within these miniature devices. Combining microfluidic devices with the inserts described herein allow further advances in the in-device purification and fractionation of biological molecules. Additionally, with inserts of the proper specificity, specific polypeptides or gene sequences, as well as protein/protein, protein/DNA, and/or RNA/DNA complexes may be isolated. In certain microfluidic devices, more than one insert may be used simultaneously to allow concurrent fractionation of multiple, and different, biological molecules of interest.

Provided herein is a microfluidic device having more than one insert specific for a particular species of biological material (e.g., protein, DNA, RNA, lipids, carbohydrates, or specific polypeptides or proteins or gene sequences depending on the manner in which the solid phase support is prepared), such that multiple independent isolation, purification, concentration and/or fractionation procedures can be carried out at the same time in the same microfluidic device. In some embodiments of a microfluidic device as provided herein, an antimicrobial material may coat the fluid receiving chamber or portions thereof.

7. Device Inserts

Provided herein are liquid handling and sample preparation devices useful for isolation, purification, concentration and/or fractionation of biological materials, such as nucleic acids and polypeptides, for example. Such devices include solid phase supports that bind to biological materials by specific or non-specific interactions, which in certain embodiments, are non-coated capillary tubes arranged in a multicapillary array or bundle, or coated capillary tubes arranged in a multicapillary array or bundle or beads, particles, gels, fibers and the like. The solid phase supports are incorporated into a disposable pipette tip or manufactured as a pipette tip extension constructed from a thermoplastic or polymer, in certain embodiments. In some embodiments, solid phase supports are incorporated into laboratory liquid handling tubes and specimen containers. In certain embodiments, solid phase supports can be incorporated in a microfluidic device.

An “insert” as used herein often comprises a solid phase that can interact with a biomolecule. The term “solid support” or “solid phase” as used herein refers to an insoluble material with which a biomolecule can be associated, directly or indirectly. As used herein the term “entity” refers to solid phase supports described herein (e.g., multicapillary elements, beads, particles, gels, fibers, and the like), and may be used within any of the devices described herein. An entity may also be used per device, such as glass multicapillary inserts within the tip of a pipette tip, or as a mixture or combination thereof, such as multicapillary-channeled polymeric fibers within a syringe.

The cross section shape of the insert can depend on the cross section shape of each capillary and on the number of capillaries utilized to manufacture the insert. For example, if a rod or tube with a circular cross-section is used, the resultant multicapillary bundle can approximate the same circular cross-sectional shape. Thus, inserts formed using monolithic elements sometimes assume the cross-sectional shape of the monolithic element used as the boundary. In embodiments where a greater number of cylindrical capillaries are utilized, the cross section of the insert sometimes is polygonal. Also, the smaller the diameter of the capillary tubes used, the closer the cross-sectional shape can be to the true cross-sectional shape of the boundary monolithic element. In the case of larger diameter capillary tubes, the cross-sectional shape of the insert sometimes is circular due to the boundary, however, the perimeter of the capillary tubes inside the circular boundary can assume a shape closer to a multi-sided polygon. This feature is due to the packing density that can be achieved using boundary monolithic elements and capillary tubes of varying sizes. A general rule of thumb is the smaller the capillaries inserted into the monolithic element, the closer the cross-sectional shape will be to a circle. Alternative capillary cross sectional shapes can provide a greater packing density due to the “stacking” of the alternatively shaped capillaries within the outer monolithic boundary element.

A surface of an insert (e.g., capillary inner surface) can be coated or charged with a material in certain embodiments. A coated surface in certain embodiments is a solid support coated with a material known to bind by specific or non-specific interactions to a biological material of interest. Examples of non-specific interactions include without limitation hydrophobic (e.g., C18-coated solid support and tritylated nucleic acid), electrostatic, ionic, van der Walls and polar (e.g., “wetting” association between nucleic acid/polyethylene glycol) interactions and the like. Examples of specific interactions include binding pair interactions, for example, such as affinity binding pair interactions. Examples of binding pair interactions include without limitation antibody/antigen, antibody/antibody, antibody/antibody fragment, antibody/antibody receptor, antibody/protein A or protein G, protein/ligand, hapten/anti-hapten, biotin/avidin, biotin/streptavidin, polyhistidine/bivalent metal (e.g., copper), glutathione/glutathione-S-transferase, folic acid/folate binding protein, vitamin B12/intrinsic factor, nucleic acid/complementary nucleic acid (e.g., DNA, RNA, PNA) interactions and the like. Antibodies include without limitation IgG, IgM, IgA, IgE, or an isotype thereof (e.g., IgG₁, IgG₂ₐ, IgG_{2b} or IgG₃). Other coatings include without limitation carbohydrates, lipids, glycosylated proteins or polypeptides, aromatic hydrocarbons, and the like. A solid phase also may include a coating that covalently links to a biomolecule. Non-limiting examples of molecules that can covalently link to biomolecules of interest include chemical reactive group/complementary chemical reactive group pairs (e.g., sulfhydryl/maleimide, sulfhydryl/haloacetyl derivative, amine/isotriocyanate, amine/succinimidyl ester, and amine/sulfonyl halides), and the like. Examples of specific and non-specific association agents affinity binding agents and methods for linking them to a solid phase are described in U.S. Patent Application publication no. 2007/0017870, published on Jan. 25, 2007. A coating in some embodiments renders uniform or substantially uniform the inner diameter of capillaries in a multicapillary structure (e.g., aliphatic, aromatic, organoelement and inorganic moieties described in U.S. Pat. No. 7,166,212, issued Jan. 23, 2007, entitled “Multicapillary column for chromatography and sample preparation,” to Belov et al.). In certain embodiments, a solid phase is coated with one or more materials (e.g., a material that renders the inner diameter of capillaries substantially uniform and a material that specifically or non-specifically associates with polypeptides). A solid phase in certain embodiments may be naked and not include a coated material (e.g., a glass or etched glass solid phase that associates with nucleic acid). Coated materials may be in association with a solid phase by covalent and/or non-covalent interactions. In some embodiments of an insert device as provided herein, an antimicrobial material may coat the exposed surface areas of the device or portions thereof.

In certain methods and devices used for processing biological or environmental materials, for example, recovered material may be lost or contaminated (e.g. microbial contamination) or damaged (e.g., nicked or sheared in the case of nucleic acids, denatured or incorrectly folded in the case of proteins) due to mechanical forces exerted (e.g., heat transfer, acute centrifugal force, and air resistance). For example, a biomolecule may be structurally altered by the contamination of microbes within the sample preparation devices used. Therefore the impaired quality of the resultant biological samples extracted using certain devices may be undesirable to the user. The structure and purity of biomolecules prepared using devices described herein generally remain unaltered or less altered as compared to techniques in use by the person of ordinary skill in the art, and processes and devices described herein do not substantially modify the structures or purity of the prepared biomolecules. For example, samples prepared using the sample preparation devices provided herein minimize microbial contamination as well as nicking and shearing of nucleic acids resulting in greater recovery of intact nucleic acids, including chromatin, genomic DNA, and nucleic acids with certain secondary and tertiary structural conformations. In general, nucleic acids isolated by the sample preparation devices herein, will have a greater structural integrity for subsequent analysis. Additionally, use of the sample preparation devices provided herein will result in a greater yield of intact polypeptides and proteins with correct folding and intact structural integrity, also due to the advantages of using antimicrobial, non-centrifugal means to isolate, purify, concentrate and/or fractionate the polypeptides or proteins.

Sample preparation devices provided herein are useful for efficient recovery of a biomolecule in a sample. Application of an antimicrobial substance within these devices increases the probability of purity and non-contamination of the sample after use in the device. In some embodiments, a sample preparation antimicrobial device provided herein may be used to recover about 30%, 40%, 50%, 60%, 70%, 80%, 90%, or more of a biomolecule recoverable from a sample. One of skill in the art will be aware of the need to balance the purity of the starting materials with the size and purity of the sample preparation device for optimal recovery of the biological material of interest. To provide a wider range of options for the person of ordinary skill in the art, the sample preparation antimicrobial devices provided herein are configured in a number of different sizes to allow effective antimicrobial recovery of the material of interest from a wide range of starting materials and samples.

Examples of various inserts are described hereafter.

a. Multicapillary Inserts

Glass capillary tubes are provided in certain multicapillary inserts embodiments, and recent advances in polymer science has enabled the development of a number of polymer plastics, that not only exhibit low retention and suitable flow characteristics, but have also been determined to act themselves as chromatographic agents. Published U.S. Patent Application 2006/020188A1 to Marcus et al. shows that polypropylene materials can be used as a solid phase, for example. Thus, any suitable polymer can be used in multicapillary inserts.

Multicapillary inserts are known to the person of ordinary skill in the art. Examples of multicapillary bundles are described in U.S. Pat. No. 7,166,212 issued on Jan. 23, 2007, supra. A multicapillary bundle can be formed by piercing a monolithic element (rod, tube, etc.) with multiple capillaries, for example. In another example, a multicapillary bundle can be formed by shrink-wrapping plastic, metal, or metal oxides around capillary tubes to form the bundle. Thus, multicapillary inserts sometimes are referred to as multicapillary bundles or arrays. The assembled insert (e.g., monolithic element and capillary tubes) contains voids. The voids are the channels that are created by the capillary tubes within the outer boundary of the monolithic element, or the voids can also be the channels created between the external surfaces of adjacent capillary tubes. Dimensions of multicapillaries in an insert can be of any convenient dimensions for interacting with a biomolecule and for use with a pipettor. The inner diameter of capillaries in a multicapillary insert can be, for example, from about 0.1 micrometers to about 100 micrometers, and in certain embodiments, about 0.1, 0.5, 1, 5, 10, 50 or 100 micrometers. The length of each capillary in a multicapillary insert can be, for example, 0.1 millimeter to about 10 centimeters, and in certain embodiments, about 0.1, 0.5, 1, 5, 10, 50 or 100 millimeters. A multicapillary insert can have any suitable number of capillaries for liquid handling and biomolecule extraction, and can include without limitation, about 100, 200, 300, 400, 500, 600, 700, 800, 900, 1000, 1250, 1500, 1750, 2000, 2250, 2500, 2750, 3000, 3250, 3500, 3750, 4000, 4250, 4500, 4750, 5000, 6000, 7000, 8000, 9000 or 10,000 capillaries.

The capillaries and insert can be of any cross-sectional geometry (circular, oval, polygonal, (e.g., hexagon, octagon), and the like) such that the insert can be fitted within a pipette tip. The maximum diameter of an insert often is equal to or greater than the diameter of the fluid discharge void of a pipette tip, and the length of an insert generally is no longer than the vertical length of a pipette tip. In certain embodiments, the diameter of an insert cross section is about 0.01 to about 20 millimeters (e.g., about 0.01, 0.05, 0.10, 0.50, 1, 2, 3, 4, 5, 6, 7, 8, 9, 10, 11, 12, 13, 14, 15, 16, 17, 18, 19 or 20 millimeter diameter), sometimes about 0.1 millimeters to about 10 millimeters, and at times about 1.1, 2.3, 3.2 or 3.1 millimeters. In some embodiments, the length of an insert is about 0.1 to about 100 millimeters (e.g., 0.1, 0.5, 1, 2, 3, 4, 5, 6, 7, 8, 9, 10, 15, 20, 30, 40, 50, 60, 70, 80, 90 or 100 millimeter length). In some embodiments of a multicapillary device as provided herein, an antimicrobial material may coat the inner and/or outer surface of the device, the exposed surface areas or portions thereof.

b. Beads and Particles

In addition to the inserts described in the embodiments above, pipette tip devices and pipette tip extension devices can comprise beads and/or particles that can associate with biomolecules under certain conditions. Beads and particles can be loaded into pipette tips in combination with structures that retain the beads in a fixed position within the pipette tip device or pipette tip extension device. Beads or particles also may be sintered, as described hereafter.

The term “beads” as used herein refers to particles and other solid supports suitable for associating with biomolecules. Beads may have a regular (e.g., spheroid, ovoid) or irregular shape (e.g., rough, jagged), and sometimes are non-spherical (e.g., angular, multi-sided). Beads are porous in certain embodiments, and may be non-porous in certain applications. Particles or beads having a diameter (e.g., nominal, average, mean or maximum diameter) greater than the minimum opening of a retention structure generally are utilized. Particles or beads having a nominal, average or mean diameter of about 1 nanometer to about 500 micrometers can be utilized, such as those having a nominal, mean or average diameter, for example, of about 10 nanometers to about 100 micrometers; about 100 nanometers to about 100 micrometers; about 1 micrometer to about 100 micrometers; about 10 micrometers to about 50 micrometers; about 1, 5, 10, 15, 20, 25, 30, 35, 40, 45, 50, 55, 60, 65, 70, 75, 80, 85, 90, 95, 100, 200, 300, 400, 500, 600, 700, 800 or 900 nanometers; or about 1, 5, 10, 15, 20, 25, 30, 35, 40, 45, 50, 55, 60, 65, 70, 75, 80, 85, 90, 95, 100, 200, 300, 400, 500 micrometers.

A bead or particle can be manufactured from a variety of insoluble or solid materials known to the person of ordinary skill in the art. For example, the bead or particle can comprise or consist essentially of silica gel, glass (e.g. controlled-pore glass (CPG)), nylon, Sephadex®, Sepharose®, cellulose, a metal surface (e.g. steel, gold, silver, aluminum, silicon and copper), a magnetic material, a plastic material (e.g., polyethylene, polypropylene, polyamide, polyester, polyvinylidenedifluoride (PVDF)) and the like. Beads or particles may be swellable (e.g., polymeric beads such as Wang resin) or non-swellable (e.g., CPG). Commercially available examples of beads include without limitation Wang resin, Merrifield resin and Dynabeads®. Beads may also be made as solid particles or particles that contain internal voids. A pipette tip or pipette tip extension device may include one type of bead, or two or more types of beads, in certain embodiments.

The person of ordinary skill in the art is familiar with methods for loading beads into laboratory structures. Beads may be loaded into a pipette tip or pipette tip extender device by pouring free flowing beads into the device without application of a compression force, in some embodiments. In certain embodiments, beads are compressed (e.g., tamped) in the device after they are loaded. The person of ordinary skill in the art can select a suitable compression force for embodiments in which beads are compressed in the device after loading. In certain embodiments, a compression force is selected that retains appropriate fluid handling parameters and/or does not significantly alter bead structure.

Beads can be treated with materials that facilitate association with biomolecules. The person of ordinary skill in the art can readily select and employ such materials, which include materials described herein.

Beads are retained in a pipette tip or pipette extension device by a retention structure. A “retention structure” as defined herein is a component or aperture in the device, or in connection with the device, that has a minimum aperture less than the nominal, average or mean diameter of the beads. Non-limiting examples of retention structures are structures having an aperture in the fluid emitting terminus of a pipette tip or pipette tip extension device having a diameter (e.g., nominal, average, mean or maximum diameter) or minimum length less than the bead diameter, in certain embodiments. In some embodiments, the structure is a slot located at the fluid emitting terminus. In certain embodiments, the structure contains multiple apertures (e.g., 2, 3, 4, 5, 6, 7, 8, 9, 10, 20, 30, 40, 50 or more apertures), such as an array of apertures in a grid, sieve or mesh (e.g., plastic, wire mesh; array of parallel slots), for example. In certain embodiments, the aperture-containing structure is located at the fluid emitting terminus of the pipette tip or pipette tip extension device. In the latter embodiments, the fluid emitting terminus of the device may be of any convenient shape, including but not limited to angled, sharp, piercing, elliptical, rounded, flat, multifaceted and the like (e.g., the aperture (e.g., slot) may be located in one or more faces or facets of the tip). In some embodiments, the aperture-containing structure is located in a structure separate from, and in sealing contact with (e.g., adhesive or friction fit contact), the pipette tip or pipette tip extension device (e.g., a basket containing a grid array of apertures in sealing connection with the fluid emitting end of a pipette tip device). Non-limiting examples of retention structures also include a plug having a mean, average, nominal or maximum pore diameter less than the bead diameter, in certain embodiments. The person of ordinary skill in the art can select plugs appropriate for retaining beads in a pipette tip or pipette tip extension device (e.g., U.S. Pat. No. 5,851,491 to Moulton), and in certain embodiments, are manufactured from a fibrous material. A plug can be of any shape suitable for retaining beads in a pipette tip or pipette tip extension device, and in certain embodiments, a plug has vertical sides or tapered sides with respect to the top and/or bottom plug surfaces. A plug sometimes is compressed in the pipette tip or pipette tip extension device after it is loaded into the device by a force determined by the person of ordinary skill in the art. Plugs can be located along any portion of a device suitable for fluid operation of the device. In certain embodiments, a plug is located only in about the lower 70%, 60%, 50%, 40%, 30% or 20% of the length of a pipette tip or pipette tip extension device. In some embodiments for devices containing a plug above the beads, there is a void between the bottom surface of said plug and the top surface of the beads. In certain embodiments, the void is up to about 90% of the volume of the pipette tip or pipette tip extension device (e.g., the void is about 5%, 10%, 15%, 20%, 25%, 30%, 35%, 40%, 45%, 50%, 55%, 60%, 65%, 70%, 75%, 80%, 85% or 90% of the pipette tip or pipette tip extension device volume). A pipette tip or pipette tip extension device includes, in certain embodiments, one or more protrusions (e.g., annular protrusions) that can facilitate retention of a plug in a particular location of the device. A pipette tip or pipette tip extension device can include one plug or two or more plugs, in certain embodiments. In some embodiments of a bead or particle device as provided herein, an antimicrobial material may coat the exposed surface areas or portions thereof.

c. Fibers and Gels

An insert in one or more embodiments is of a gel media. For example a gel media may include silica, silica hydrogel, sephadex, sephacryl, sepharose, superose, tyopearls, ultrogel and beaded cellulose or the like.

An insert in certain embodiments is a fiber or multi-fiber insert. Multi-fiber inserts can also be referred to as multi-fiber bundles. Optic fibers, glass fibers and polymer fibers (e.g., charged or uncharged polymers) are non-limiting examples of types of fibers that can be utilized. Published U.S. Patent Application Publication No. 2006/0201881, published Sep. 14, 2006, entitled “Capillary-channeled polymeric fiber as solid phase extraction media,” to Marcus et al. shows that polypropylene fibers can be used as a solid phase, for example. Thus, any suitable polymer fibers can be used in inserts. Fibers can also be etched, channeled, charged, scintered, or combinations thereof.

Fiber bundles are known to the person of ordinary skill in the art. Examples of fiber bundles are described in U.S. Pat. No. 5,851,491, issued on Dec. 22, 1998, entitled “Pipette tip and filter for accurate sampling and prevention of contamination,” to Moulton; in U.S. Pat. No. 5,460,781, issued Oct. 24, 1995, entitled “Hemoglobin sampler,” to Hori et al.; in U.S. Pat. No. 4,657,742, issued on Apr. 14, 1987, entitled “Packed fiber glass reaction vessel,” to Beaver; and in U.S. Patent Application Publication No. 2006/0216206, published Sep. 28, 2006, entitled “Solid phase extraction pipette,” to Hudson et al. A multi-fiber bundle can be formed by piercing a monolithic element (rod, tube, etc.) with multiple capillaries, for example. In another example, a multi-fiber bundle can be formed by shrink-wrapping plastic, metal, or metal oxides around fibers to form the bundle. Thus, multi-fiber inserts sometimes are referred to as multi-fiber bundles or arrays. The assembled insert (e.g., monolithic element and fibers) contains voids. The voids in certain embodiments are channels between the external surfaces of adjacent fibers. Fibers in an insert sometimes are oriented in a substantially uniform direction, and not randomly distributed. In other embodiments, fibers are randomly distributed in the insert. Fibers in an insert can be of any convenient dimensions for interacting with a biomolecule and for use with a pipettor. The diameter of fibers in an insert can be, for example, from about 0.01 micrometers to about 100 micrometers, and in certain embodiments, about 0.01, 0.05, 0.1, 0.5, 1, 5, 10, 50 or 100 micrometers. The length of each fiber in an insert can be, for example, 0.001 millimeter to about 100 millimeters, and in certain embodiments, about 0.001, 0.005, 0.01, 0.05, 0.1, 0.5, 1, 5, 10, 50 or 100 millimeters. A multi-fiber insert can have any suitable number of capillaries for liquid handling and biomolecule extraction, and can include without limitation, about 100, 200, 300, 400, 500, 600, 700, 800, 900, 1000, 1250, 1500, 1750, 2000, 2250, 2500, 2750, 3000, 3250, 3500, 3750, 4000, 4250, 4500, 4750, 5000, 6000, 7000, 8000, 9000 or 10,000 fibers. In some embodiments of a fiber or gel device as provided herein, an antimicrobial material may coat the exposed surface areas or portions thereof.

d. Sintered Inserts

An insert in certain embodiments, is a sintered bead insert. Sintered bead inserts can be manufactured, for example, by delivering free-flowing beads to a form (e.g., a cylindrical form having an open top), and heating the beads such that contact points between beads partially melt. The resulting insert then is removed from the form. Beads in the outer perimeter of such inserts sometimes melt or partially melt and form a continuous wall or sheath around the insert. Beads described herein that can melt or partially melt in a sintering process can be utilized, and in one embodiment, silica glass beads are utilized.

The insert, and in applicable embodiments the fibers of an insert, can be of any cross-sectional geometry (circular, oval, polygonal, (e.g., hexagon, octagon), and the like) such that the insert can be fitted within a pipette tip. The maximum diameter of an insert often is equal to or greater than the diameter of the fluid discharge void of a pipette tip, and the length of an insert generally is no longer than the vertical length of a pipette tip. In certain embodiments, the diameter of an insert cross section is about 0.01 to about 20 millimeters (e.g., about 0.01, 0.05, 0.10, 0.50, 1, 2, 3, 4, 5, 6, 7, 8, 9, 10, 11, 12, 13, 14, 15, 16, 17, 18, 19 or 20 millimeter diameter), and in some embodiments the length of an insert is about 0.1 to about 100 millimeters (e.g., 0.1, 0.5, 1, 2, 3, 4, 5, 6, 7, 8, 9, 10, 15, 20, 30, 40, 50, 60, 70, 80, 90 or 100 millimeter length). In inserts arranged using regularly aligned fibers, the cross section shape of the insert can depend on the cross section shape of each fiber and on the number of fibers utilized to manufacture the insert. For example, if a rod or tube with a circular cross-section is used, the resultant fiber bundle can approximate the same circular cross-sectional shape. Thus, inserts formed using monolithic elements sometimes assume the cross-sectional shape of the monolithic element used as the boundary. In embodiments where a greater number of cylindrical fibers are utilized, the cross section of the insert sometimes is polygonal. Also, the smaller the diameter of the fibers used, the closer the cross-sectional shape can be the true cross-sectional shape of the boundary monolithic element. In the case of larger diameter fibers, the cross-sectional shape of the insert sometimes is circular due to the boundary, however, the perimeter of the fibers inside the circular boundary assume a shape closer to a multi-sided polygon. This feature is due to the packing density that can be achieved using boundary monolithic elements and fibers of varying sizes. A general rule of thumb is the smaller the fibers inserted into the monolithic element, the closer the insert cross-sectional shape will be to a circle. Alternative fiber cross sectional shapes can provide a greater packing density due to the “stacking” of the alternatively shaped fibers within the outer monolithic boundary element. In some embodiments of a sintered insert device as provided herein, an antimicrobial material may coat the exposed surface areas or portions thereof.

### C. Processing Biological Molecules

The inserts and beads used in the devices described herein are useful for isolation, purification, concentration and/or fractionation of biological agents, including without limitation peptides, polypeptides, proteins, nucleic acids and cells, and other biological agents can also be isolated with the appropriately configured inserts and beads.

The term “biomolecule” or “biological agent” or “biological reagent” as used herein refers to a material from a biological sample. A biological sample is any sample derived from an organism or environment, including without limitation, tissue, cells, a cell pellet, a cell extract, or a biopsy; a biological fluid such as urine, blood, saliva or amniotic fluid; exudate from a region of infection or inflammation; a mouth wash containing buccal cells; cerebral spinal fluid or synovial fluid; environmental, archeological, soil, water, agricultural sample; microorganism sample (e.g., bacterial, yeast, amoeba); organs; and the like. A biomolecule includes without limitation a cell, a group of cells, an isolated cell membrane, a cell membrane component (e.g., membrane lipid, membrane fatty acid, cholesterol, membrane protein), a saccharide, a polysaccharide, a nucleic acid (e.g., deoxyribonucleic acid (DNA), ribonucleic acid (RNA), protein nucleic acid (PNA)), a peptide and a polypeptide (e.g., a protein, a protein subunit, a protein domain) and the like. A sample sometimes is processed to liberate biomolecules of interest before a biomolecule is contacted with a device described herein. For example, cells can be lysed using methods well known in the art before the sample is contacted with a device herein.

The terms “isolated”, “isolating” or “isolation” as used herein refer to material removed from its original environment (e.g., the natural environment if it is naturally occurring, or a host cell if expressed exogenously), and thus is altered “by the hand of man” from its original environment. The terms “isolated”, “isolating” or “isolation” and “purified”, “purifying” or “purification” as used herein with reference to molecules does not refer to absolute purity. Rather, “purified”, “purifying” or “purification” refers to a substance in a composition that contains fewer substance species in the same class (e.g., nucleic acid or protein species) other than the substance of interest in comparison to the sample from which it originated. “Purified”, “purifying” or “purification”, if a nucleic acid or protein for example, refers to a substance in a composition that contains fewer nucleic acid species or protein species other than the nucleic acid or protein of interest in comparison to the sample from which it originated. “Concentrated”, “concentrating”, or “concentration” refers to the act of increasing the “molarity” of a substance species (e.g., nucleic acid or protein species), without also substantially increasing the molarity of any salts, buffering agents or other chemicals present in the sample solution. “Fractionated”, “fractionating” or “fractionation” as used herein refers to the act of separating similar or dissimilar substance species using a chromatographic approach, for example, fractionation of nucleic acids extracted from a cell, where the object of fractionation is to remove protein or RNA, but maintain DNA, and sometimes the total population of DNA. The DNA can be fractionated from other substance species, but the result is different from purification because there are not fewer substance species in the same class.

As used herein, the term “polypeptide” refers to a molecular chain of amino acids and does not refer to or infer a specific length of the amino acid chain. Thus peptides, oligopeptides, and proteins are included within the definition of polypeptide. This term is also intended to include polypeptides that have been subjected to post-expression modifications such as glycosylations, acetylations, phosphorylations, and the like. As used herein, the term “protein” refers to any molecular chain of amino acids that is capable of interacting structurally, enzymatically or otherwise with other proteins, polypeptides, RNA, DNA, or any other organic or inorganic molecule.

As used herein, “nucleic acid” refers to polynucleotides such as deoxyribonucleic acid (DNA) and ribonucleic acid (RNA). The term should also be understood to include, as equivalents, derivatives, variants and analogs of RNA or DNA made from nucleotide analogs, single (sense or antisense) and double-stranded polynucleotides. It is understood that the term “nucleic acid” does not refer to or infer a specific length of the polynucleotide chain, thus nucleotides, polynucleotides, and oligonucleotides are also included in the definition. Deoxyribonucleotides include deoxyadenosine, deoxycytidine, deoxyguanosine and deoxythymidine. For RNA, the uracil base is uridine. Different forms and types of nucleic acids can be contacted by devices described herein, including without limitation, genomic, plasmid, circular, linear, hairpin, ribozyme, antisense, triplex, short heteronuclear RNA (shRNA), short inhibitory RNA (siRNA) and inhibitory RNA (RNAi).

As used herein “material that binds to a nucleic acid” refers to any organic or inorganic molecules that can specifically or non-specifically bind to a nucleic acid. Included in the category “organic or inorganic molecule” are peptides, polypeptides, proteins, proteins subjected to post-translational modification, other nucleic acids, nucleic acids containing modified nucleotides, and antibodies. The material bound to nucleic acid sometimes is present in a sample from which the nucleic acid is being processed, such as cellular components that bind to nucleic acid.

As used herein, “biomolecule association conditions” or “biological agent association conditions” refers to conditions under which a biomolecule or biological agent associates with a bead or insert solid support. The term “associates” as used herein refers to specific and/or non-specific interactions between the biomolecule or biological agent and a solid phase. The association often is reversible, in some embodiments is irreversible, and sometimes the association is a binding interaction. Biomolecule association conditions in some embodiments are specific temperatures and/or concentrations of certain components that facilitate association of a biomolecule or biological agent to a bead or insert solid support, including without limitation, salt, buffer agent, carrier molecule and chaotrope concentration. As used herein, the term “wash” refers to exposing a solid support to conditions that remove materials from the solid support that are not the biological agent(s) of interest. As used herein, the term “elute” refers to exposing a solid support to conditions that de-associate the biological agent(s) of interest from the solid support.

In certain embodiments, a nucleic acid (e.g., DNA) is associated with a glass solid support (e.g., silica) in an insert or bead, and several association conditions are known in the art (e.g., World Wide Web URL biology-web.nmsu.edu/nish/Documents/reprints %20&%20supplemental/DNA%20Isolation%20Procedures.pdf). For example, it is known that DNA binds to silica under conditions of high ionic strength and/or high chaotrope concentration. High DNA adsorption efficiencies are shown to occur in the presence of a buffer solution having a pH at or below the pKa of the surface silanol groups.

Biomolecule binding conditions sometimes are categorized as being of low stringency or high stringency. Devices described herein can be utilized at elevated temperatures for use with stringent hybridization protocols. An example of stringent hybridization conditions is hybridization in 6× sodium chloride/sodium citrate (SSC) at about 45° C., followed by one or more washes in 0.2×SSC, 0.1% SDS at 50° C. Another example of stringent hybridization conditions are hybridization in 6× sodium chloride/sodium citrate (SSC) at about 45° C., followed by one or more washes in 0.2×SSC, 0.1% SDS at 55° C. A further example of stringent hybridization conditions is hybridization in 6× sodium chloride/sodium citrate (SSC) at about 45° C., followed by one or more washes in 0.2×SSC, 0.1% SDS at 60° C. Another stringent hybridization conditions are hybridization in 6× sodium chloride/sodium citrate (SSC) at about 45° C., followed by one or more washes in 0.2×SSC, 0.1% SDS at 65° C. Certain stringency conditions are 0.5M sodium phosphate, 7% SDS at 65° C., followed by one or more washes at 0.2×SSC, 1% SDS at 65° C.

Nucleic acid binding can also occur by other specific or nonspecific means. Non-limiting examples of nucleic acid binding conditions are high salt binding (high ionic conditions as in the case of non-specific interactions with glass) where DNA binding occurs in the range of 0.75M sodium chloride to 1.25M sodium chloride, followed by elution with concentrations of sodium chloride ranging from 1.25M to 1.6M; low salt binding (low ionic conditions as in the case for C18 coated solid supports) where non specific hydrophobic binding occurs in aqueous buffers with concentrations in the range of 0 to 0.1 Molar (M) salts, and where the bound nucleic acids can be eluted with increasing gradients of organic mobile phase, like acetonitrile, up to 30%, up to 40%, 50%, 60%, 70%, 80%, and even 90%, for example. The exact binding and elution conditions being dependent on the size and sequence of the nucleic acid. Further nucleic acid binding conditions available in the protocols of the following commercially available catalogs: PureLink quick plasmid miniprep kit (Invitrogen, Cat. No. K2100-10 or K2100-11), Wizard plus SV Minipreps DNA purification System (Promega, Cat. No. A1330 or A1460), QIAprep Spin Miniprep Kit (Qiagen, Cat. No. 27104 or 27106) and GenElute plasmid kids (Cat. No. PLN-50, PLN-70, PLN-250 and PLN-350).

A bind-wash-elute procedure can be utilized to process a nucleic acid from a sample using a device described herein. In certain embodiments, nucleic acids are adsorbed to a solid support comprising silica in the presence of one or more chaotropic agents, which remove water from hydrated molecules in solution. Examples of chaotropic agents include without limitation guanidinium salts (e.g., guanidinium hydrochloride and guanidium thiocyanate) and urea, and can be utilized at concentrations of 0.5M to 7M in certain embodiments. Polysaccharides and proteins do not adsorb to the solid support and are removed. After a wash step, nucleic acids are eluted under low- or no-salt conditions in small volumes, ready for immediate use without further concentration. Nucleic acid may first be isolated from a sample source (e.g., cells) by methods known to the person of ordinary skill in the art. For example, an alkaline lysis procedure may be utilized. The latter procedure traditionally incorporates the use of phenol-chloroform solutions, and an alternative phenol-chloroform-free procedure involving three solutions can be utilized. In the latter procedures, solution 1 can contain 15 mM Tris, pH 8.0; 10 mM EDTA and 100 ug/ml Rnase A; solution 2 can contain 0.2N NaOH and 1% SDS; and solution 3 can contain 3M KOAc, pH 5.5.

A bind-wash-elute procedure also can be utilized with insert and bead solid phases comprising silica derivatized with a positively charged moiety. In certain embodiments, a silica material having a high density of diethylaminoethyl (DEAE) groups can be used to isolate nucleic acids. Isolation is based on the interaction between negatively charged phosphates of the nucleic acid backbone and positively charged DEAE groups on the surface of the resin. Other charged groups can be utilized, including without limitation diethyl-(2-hydroxypropyl)aminoethyl, trimethylamine and the like. The salt concentration and pH conditions of the buffers used in each step control binding, wash stringency, and elution of nucleic acids. Combinations of pH conditions and buffers are described at World Wide Web address URL qiagen.com/Plasmid/AnionExchangeResin.aspx. For example, a salt concentration (e.g., NaCl) in the range of about 0.4M to about 2.0M may be used with a pH in the range of about 6.0 to about 9.0 for extraction of DNA or RNA, where a higher salt concentration is utilized with a lower pH solution.

A solid phase support can be functionalized with affinity-binding reagents, such as specific gene sequences, specific peptide sequences, antibodies and other organic or inorganic molecules. Conditions for associating biomolecules with such functionalized solid phases are known in the art. Conditions for washing and eluting biomolecules from such supports also are known in the art. For example, polypeptides can be eluted by increasing amounts of organic solvents, such as acetonitrile (e.g., about 30%, 40%, 50%, 60%, 70%, 80%, 90%). One of ordinary skill in the art will appreciate that the exact binding and elution conditions will be dependent on the size and sequence of the biomolecule of interest and the solid phase to which it is associated.

Biomolecules processed using devices described herein can be detected by a method known to the person of ordinary skill in the art. Methods for detecting polypeptides are well known (e.g., Coomassie blue, Bradford reagent) and methods for detecting nucleic acids also are known. For example, measuring the intensity of absorbance of a DNA solution at wavelengths 260 nm and 280 nm is used as a measure of DNA purity. DNA absorbs ultraviolet (UV) light at 260 and 280 nm, and aromatic proteins absorbs UV light at 280 nm; a pure sample of DNA has the 260/280 ratio at 1.8 and is relatively free from protein contamination. A DNA preparation that is contaminated with protein will have a 260/280 ratio lower than 1.8. In another example, a DNA sample processed using a device described herein can be amplified using a technique known in the art, such as polymerase chain reaction (PCR) and transcription mediated amplification (TMA) processes, for example. Quantitative PCR (Q-PCR) processes are known in the art for determining the amount of a particular DNA sequence in a sample. Also, DNA can be quantified by cutting with a restriction enzyme, electrophoresing products in an agarose gel, staining with ethidium bromide or a different stain and comparing the intensity of the DNA with a DNA marker of known concentration. Nucleic acid also can be quantified by diphenylamine (DPA) indicators by spectrometric detection at 600 nm and use of a standard curve of known nucleic acid concentrations.

### D. Methods for Manufacturing Devices

A device of the present invention incorporating, carrying or coated with an antimicrobial substance may be produced by any application method or process known to those of skill in the art. In certain embodiments, application methods are utilized that direct vaporized antimicrobial substance (e.g., metal) at the device surface and deposit a thin antimicrobial film. In some embodiments processes are utilized in which a die, mold or cast is used to form the device. Below are non-limiting examples of different types of processes that can incorporate or apply an antimicrobial substance to a device.

Physical vapor deposit techniques, which include, without limitation, vacuum deposition, vacuum coating, vacuum-sputter coating, vacuum evaporation, magnetron sputtering and ion plating, are processes used to deposit layers atom-by-atom or molecule-by-molecule at sub-atmospheric pressure (vacuum) on a solid surface. The layers may be as thin as one atom and up to several millimeters thick, and there may be multiple layers of different materials. A thickness of less than one micrometer generally is referred to as a “thin film” while a thickness greater than one micrometer generally is referred to a “coating.”

“Electroplating” or “plasma arc deposition” refers to processes for depositing a metallic coating onto a device by placing a negative charge on the device and exposing the device to a solution containing a salt of the metal to be deposited. In such processes, the positively charged metal ions in the solution are reduced to metallic form onto the device.

Extrusion is a process used to create objects of a fixed cross-sectional profile. A material is pushed or drawn through a die of the desired cross-section. The two main advantages of extrusion process over other manufacturing processes is the ability to create very complex cross-sections and work materials that are brittle, because the material only encounters compressive and shear stresses. Such processes can be utilized to form finished parts with an excellent surface finish. Extrusion may be continuous (e.g., theoretically producing indefinitely long material) or semi-continuous (e.g., producing many pieces). The extrusion process can be performed with the material hot or cold.

Molding is a process of manufacture by shaping pliable raw material using a rigid frame or model called a mold. A mold often is a hollowed-out block filled with a liquid, including, without limitation, plastic, glass, metal, or ceramic raw materials. The liquid hardens or sets inside the mold, adopting its shape. A release agent sometimes is used to facilitate removal of the hardened or set substance from the mold.

Thermoforming is a manufacturing process for thermoplastic sheet or film. The sheet or film is heated between infrared, natural gas, or other heaters to its forming temperature. Then it is stretched over or into a temperature-controlled, single-surface mold. The sheet is held against the mold surface unit until cooled. The formed part is then trimmed from the sheet. The trimmed material is usually reground, mixed with virgin plastic, and reprocessed into usable sheet. There are several categories of thermoforming, including vacuum forming, pressure forming, twin-sheet forming, drape forming, free blowing, and simple sheet bending.

Injection molding is a manufacturing technique for making parts from both thermoplastic and thermosetting plastic materials in production. Molten plastic is injected at high pressure into a mold. Molds may be made from either steel or aluminum, and precision-machined to form the features of the desired part.

Casting is a manufacturing process by which a liquid material generally is flowed into a mold, which contains a hollow cavity of the desired shape, and then the liquid material is allowed to solidify. The solid casting is then ejected or broken out to complete the process. Casting may be used to form hot liquid metals or various materials that cold set after mixing of components (such as epoxies, concrete, plaster and clay). Casting is most often used for making complex shapes that would be otherwise difficult or uneconomical to make by other methods. The casting process is subdivided into two distinct subgroups: expendable and non-expendable mold casting. Expendable mold casting is a generic classification that includes sand, plastic, shell, plaster, and investment (lost-wax technique) moldings. This method of mold casting involves the use of temporary, non-reusable molds. Non-expendable mold casting differs from expendable processes in that the mold need not be reformed after each production cycle. This technique includes at least four different methods: permanent, die, centrifugal, and continuous casting.

Using any of the techniques disclosed herein or those known to one of skill in the art, a device may be manufactured by mixing the antimicrobial material into a precursor of the molded or formed material or directly into the material itself before formed. In some embodiments a device as provided herein may have the antimicrobial material manually mixed into a precursor mixture or the substance of the body itself as it is being manufactured. In certain embodiments a device as provided herein may have the antimicrobial material diffused into the body of the device as it is being manufactured. Alternatively, a device may be sprayed or coated with an antimicrobial material after formed or a combination of diffusion into the body of the device and coating after formation thereof.

### EXAMPLES

The following examples illustrate embodiments of the invention and are not limiting.

### Example 1

### Coating a Pipette Tip and Determining Antimicrobial Activity

A pipette tip is coated on the inner surface and the outer surface by magnetron sputtering an Ag—Cu-alloy onto the surface to a thickness of 0.45 microns, using either argon gas working pressures of 7 mTorr or 30 mT at 0.5 KW power and a T/Tm ratio of less than 0.5.

The anti-microbial effect of the coatings is tested by a zone of inhibition test. Basal medium Eagle (BME) with Earle's salts and L-glutamine is modified with calf/serum (10%) and 1.5% agar prior to being dispensed (15 ml) into Petri dishes. The agar containing Petri plates are allowed to surface dry prior to being inoculated with a lawn of Staphylococcus aureus ATCC#25923. The inoculant is prepared from Bactrol Discs (Difco, M.) which are reconstituted as per the manufacturer's directions. Immediately after inoculation, the pipette tips to be tested are placed on the surface of the agar. The dishes are then incubated for 24 h at 37° C. After this incubation period, the zone of inhibition is measured and a corrected zone of inhibition is calculated (corrected zone of inhibition=zone of inhibition-diameter of the test material in contact with the agar).

The results show no zone of inhibition on the uncoated tip, a zone of less than 0.5 mm around the tip coated at 7 mTorr and a zone of 13 mm around the suture coated at 30 mTorr. Clearly the pipette tip coated in accordance with the present invention exhibits a much more pronounced and effective anti-microbial effect.

### Example 2

### Silver Colloid-Treated Devices

Described is a process for preparing an antimicrobial pipette tip by molding a precursor, where inorganic particles are added to the precursor, and prior to molding at least one component of the device, the precursor is treated with a silver colloid solution where the silver colloid is stabilized by a protective agent.

Microbial reduction is evaluated by exposing treated and untreated pipette tips to microorganisms under culture conditions that encourage antimicrobial formation. This is done by placing test materials into a medium containing 0.1% neopeptone with 0.25% glucose and 1% adult bovine serum. The medium is then inoculated with 104-105 organisms from fresh 0/N cultures of clinical isolates (E. coli, methicillin-resistant Staph aureus, Pseudomonas aeruginosa, and Candida albicans). The cultures are incubated for 72 hours and then rinsed exhaustively to remove nonmicrobial organisms.

Microbial growth is quantitatively assayed by adding the metabolic dye XTT for 4 hours. The color formation is measured spectrophotometrically. The results show that treated materials had no more conversion of XTT dye than material that had never seen organisms. This finding is interpreted to mean that the silver treatment completely resists the formation of microbes.

### Example 3

### SMARTSILVER Antimicrobial Masterbatch

Described is technical specifications for the SMARTSILVER antimicrobial masterbatch material, which may be used in coating materials or molding materials for such devices as a pipettor, pipette tip, pipette tip rack, pipette tip filter, pipette tip extension, tube, centrifuge tube, syringe, microfluidic device, reagent reservoir, container or a specimen container.

The SMARTSILVER polypropylene masterbatch with additives SSB contains 4% letdown blend, 1× loading and 100 μm filtered. The fiber extrusion ratio is 4 kg additive to 96 kg polypropylene. 100 micron screen is filtered. The product form is in pellets and the size is 3.5 mm nominal. The bulk density is 475-525 kg/m³ with the pellet density being 35-37 pellets per gram and material density is 0.81-0.89 g/cm³.

### Example 4

### Examples of Embodiments

Provided hereafter are examples of certain embodiments of the technology.

1. A polymer fluid handling device comprising an antimicrobial substance in an amount effective to reduce or maintain the amount of microbe present on the device compared to a device not comprising the antimicrobial substance.

2. The polymer fluid handling device of embodiment 1, wherein the device is selected from the group consisting of a pipettor, pipette tip, pipette tip rack, pipette tip filter, pipette tip extension, tube, centrifuge tube, syringe, microfluidic device, reagent reservoir, container and specimen container.

3. The polymer fluid handling device of embodiment 1 or 2, wherein the antimicrobial substance is an antimicrobial metal and the antimicrobial metal is selected from the group consisting of silver, an alloy or compound containing silver, gold, an alloy or compound containing gold and an alloy or compound containing both silver and gold.

4. The polymer fluid handling device of any one of the preceding embodiments, wherein the amount of antimicrobial substance is in an amount between about 0.1% to about 10% based on the dry weight of the polymer.

5. The polymer fluid handling device of any one of the preceding embodiments, wherein the antimicrobial substance is in a coating deposited on a surface of the device.

6. The polymer fluid handling device of embodiment 5, wherein the amount of antimicrobial substance is in an amount between about 0.1% to about 5% based on the dry weight of the coating applied to the device.

7. The polymer fluid handling device of embodiment 6, wherein the amount of antimicrobial substance is in an amount between about 0.5% to about 5% based on the dry weight of the coating applied to the device.

8. The polymer fluid handling device of any one of embodiments 5-7, wherein the antimicrobial substance is deposited as a layer having a thickness between about 2 angstroms and about 10 microns.

9. The polymer fluid handling device of any one of embodiments 5-7, wherein the antimicrobial substance is deposited by a physical vapor deposition technique selected from vacuum evaporation, sputtering, magnetron sputtering or ion plating, under conditions which limit diffusion during deposition and which limit annealing or recrystallization following deposition.

10. The polymer fluid handling device of any one of embodiments 5-9, wherein the antimicrobial substance is deposited such that the ratio of the temperature of the surface being coated to the melting point of the substance is maintained at less than about 0.5.

11. The polymer fluid handling device of any one of embodiments 1-10, which comprises an entity that interacts with a biological molecule.

12. The polymer fluid handling device of embodiment 11, wherein the biological molecule is a nucleic acid, peptide or protein.

13. The polymer fluid handling device of embodiment 12, wherein the biological molecule is a nucleic acid.

14. The polymer fluid handling device of embodiment 13, wherein the entity is selected from the group consisting of silica, silica gel and controlled pore glass.

15. The polymer fluid handling device of any one of embodiments 1-14, wherein the fluid handling device is a pipette tip.

16. The polymer fluid handling device of embodiment 15, wherein the volume of the pipette tip ranges from 0 to 10 microliters, 0 to 20 microliters, 1 to 100 microliters, 1 to 200 microliters or from 1 to 1000 microliters.

17. The polymer fluid handling device of embodiment 15 or 16, wherein:

the pipette tip comprises a continuous and tapered polymer wall defining a first void and a second void located at opposite termini, wherein the cross section of the first void and the cross section of the second void are substantially circular and substantially parallel, and the diameter of the first void is less than the diameter of the second void, and an annular protrusion coextensive with the inner surface of the wall;

the cross section of the annular protrusion is substantially parallel to the cross section of the first void and the second void; and

the wall and the annular protrusion are constructed from the same polymer.

18. The polymer fluid handling device of embodiment 15 or 16, wherein:

the pipette tip comprises a continuous and tapered first wall defining a first void and a second void located at opposite termini, wherein the cross section of the first void and the cross section of the second void are substantially circular and substantially parallel, and the diameter of the first void is greater than the diameter of the second void, and a continuous and tapered second wall defining the second void and a third void located at opposite termini;

the cross section of the second void and the cross section of the third void are substantially circular and substantially parallel;

the diameter of the second void is greater than the diameter of the third void;

the second wall is coextensive with the first wall and the first wall and second wall are constructed from the same polymer; and

the taper angle of the second wall is less than the taper angle of the first wall.

19. The polymer fluid handling device of any one of the preceding embodiments, wherein the antimicrobial substance is selected from the group consisting of 4′,5-dibromosalicylanilide; 3,4′,5-tribromosalicylanilide; 3,4′,5-trichlorosalicylanilide; 3,4,4′-trichlorocarbanilide; 3-trifluoromethyl-4,4′-dichlorocarbanilide; 2,2′-methylenebis(3,4,6-trichlorophenol); 2,4,4′-trichloro-2′-hydroxydiphenyl ether; Tyrothricin; N-methyl-N-(2-hydroxyethyl-N-(2-hydroxydodecyl)-N-benzylammonium chloride; cetyl pyridinium chloride; 2,3′,5-tribromosalicylanilide; chlorohexidine digluconate; chlorohexidine diaceate; 4′,5-dibromosalicylanilide; 3,4,4′-trichlorocarbanilide; 2,4,4′-trichloro-2-hydroxydiphenyl ether (TRICLOSAN; 5-chloro-2-(2,4-dichlorophenoxy)phenol); 2,2′-dihydroxy-5,5′-dibromo-diphenyl ether).

20. A method for manufacturing a polymer fluid handling device having an antimicrobial substance, which comprises:

depositing an effective amount of an antimicrobial substance on a surface of the device; and

depositing the antimicrobial substance such that the ratio of the temperature of the surface being coated to the melting point of the substance is maintained at less than about 0.5.

21. A method for manufacturing a polymer fluid handling device having an antimicrobial substance, which comprises:

depositing an amount of an antimicrobial substance on a surface of the device;

allowing the surface to dry; and

applying an amount of an antimicrobial substance on another surface of the device.

22. A method for manufacturing a polymer fluid handling device having an antimicrobial substance, which comprises:

mixing an antimicrobial substance with a polymer to form a polymer mixture;

applying the polymer mixture to a mold;

allowing the polymer mixture to form the polymer handling device in the mold; and

releasing the polymer fluid handling device from the mold.

23. A method for using a polymer fluid handling device of any one of embodiments 12-19, which comprises contacting the biological molecule with the entity under conditions in which the biological molecule interacts with the entity.

24. The method of embodiment 23, which comprises exposing the device to conditions that release the biological molecule from the entity.

25. A polymer fluid handling device comprising a pipette tip rack, pipette tip rack lid, or pipette tip rack and pipette tip rack lid, the rack, lid or rack and lid comprising a polymer and about 2% to about 6% 5-chloro-2-(2,4-dichlorophenoxy)phenol.

26. The device of embodiment 25, wherein the rack comprises a polymer and about 2% to about 6% 5-chloro-2-(2,4-dichlorophenoxy)phenol.

27. The device of embodiment 25, wherein the lid comprises a polymer and about 2% to about 6% 5-chloro-2-(2,4-dichlorophenoxy)phenol.

28. The device of embodiment 25, wherein the rack and the lid comprise a polymer and about 2% to about 6% 5-chloro-2-(2,4-dichlorophenoxy)phenol.

29. The device of embodiment 25, wherein the polymer is polypropylene.

30. The device of embodiment 29, wherein the lid comprises about 5% 5-chloro-2-(2,4-dichlorophenoxy)phenol.

31. The device of embodiment 30, wherein the lid comprises 5% 5-chloro-2-(2,4-dichlorophenoxy)phenol.

32. The device of embodiment 25, wherein the about 2% to about 6% of the 5-chloro-2-(2,4-dichlorophenoxy)phenol is based on weight of the 5-chloro-2-(2,4-dichlorophenoxy)phenol to the weight of the polymer in the device.

33. A polymer fluid handling device comprising a pipette tip rack, pipette tip rack lid, or pipette tip rack and pipette tip rack lid, the rack, lid or rack and lid comprising a polymer and about 0.05% to about 6% zinc pyrithione by weight.

34. The device of embodiment 33, wherein the rack comprises a polymer and about 0.05% to about 6% zinc pyrithione by weight.

35. The device of embodiment 33, wherein the lid comprises a polymer and about 0.05% to about 6% zinc pyrithione by weight.

36. The device of embodiment 33, wherein the rack and the lid comprise a polymer and about 0.05% to about 6% zinc pyrithione by weight.

37. The device of any one of embodiments 33 to 36, wherein the zinc pyrithione is in an amount of about 0.40% to about 0.70% by weight.

38. The device of embodiment 37, wherein the zinc pyrithione is in an amount of about 0.525% by weight.

39. The device of embodiment 33, wherein the polymer is polypropylene.

40. The device of embodiment 39, wherein the lid comprises zinc pyrithione in an amount of about 0.40% to about 0.70% by weight.

41. The device of embodiment 40, wherein the lid comprises zinc pyrithione in an amount of about 0.525% by weight.

42. The device of embodiment 40, wherein the lid comprises zinc pyrithione in an amount of 0.525% by weight.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, yet these modifications and improvements are within the scope and spirit of the invention.

The invention illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the invention claimed. The term “a” or “an” can refer to one of or a plurality of the elements it modifies (e.g., “a device” can mean one or more devices) unless it is contextually clear either one of the elements or more than one of the elements is described. The term “about” as used herein refers to a value sometimes within 10% of the underlying parameter (i.e., plus or minus 10%), a value sometimes within 5% of the underlying parameter (i.e., plus or minus 5%), a value sometimes within 2.5% of the underlying parameter (i.e., plus or minus 2.5%), or a value sometimes within 1% of the underlying parameter (i.e., plus or minus 1%), and sometimes refers to the parameter with no variation. For example, a weight of “about 100 grams” can include weights between 90 grams and 110 grams. Thus, it should be understood that although the present invention has been specifically disclosed by representative embodiments and optional features, modification and variation of the concepts herein disclosed may be resorted to by those skilled in the art, and such modifications and variations are considered within the scope of this invention.

Embodiments of the invention are set forth in the claims that follow.

What is claimed is:

1. A polymer fluid handling device comprising a pipette tip rack, pipette tip rack lid, or pipette tip rack and pipette tip rack lid, the rack, lid or rack and lid comprising a polymer and about 0.05% to about 6% zinc pyrithione by weight.

2. The device of claim 1, wherein the rack comprises a polymer and about 0.05% to about 6% zinc pyrithione by weight.

3. The device of claim 1, wherein the lid comprises a polymer and about 0.05% to about 6% zinc pyrithione by weight.

4. The device of claim 1, wherein the rack and the lid comprise a polymer and about 0.05% to about 6% zinc pyrithione by weight.

5. The device of claim 3, wherein the zinc pyrithione is in an amount of about 0.40% to about 0.70% by weight.

6. The device of claim 5, wherein the zinc pyrithione is in an amount of about 0.525% by weight.

7. The device of claim 1, wherein the polymer is polypropylene.

8. The device of claim 7, wherein the lid comprises zinc pyrithione in an amount of about 0.40% to about 0.70% by weight.

9. The device of claim 8, wherein the lid comprises zinc pyrithione in an amount of about 0.525% by weight.

10. The device of claim 9, wherein the lid comprises zinc pyrithione in an amount of 0.525% by weight.
